(19) United States
(12) Patent Application Publication
(10) Pub. No.: US 2026/0209979 A1
(43) Pub. Date: Jul. 23, 2026

(54) RECOVERY OF ENERGY CRITICAL HIGH VALUE METALS USING FUNCTIONALIZED MATERIALS

(71) Applicant: CORNELL UNIVERSITY, Ithaca, NY (US)

(72) Inventors: Greeshma GADIKOTA, Ithaca, NY (US); Ruyi ZHENG, Xi'an Shaan (CN); Prince OCHONMA, Ithaca, NY (US); Tianhe YIN, Shenyang, Liaoning (CN); Sohaib MOHAMMED, Ithaca, NY (US); Hassnain ASGAR, Ithaca, NY (US); Dhruvi PATEL, Ithaca, NY (US); Peilong LU, Ithaca, NY (US)

(73) Assignee: CORNELL UNIVERSITY, Ithaca, NY (US)

(21) Appl. No.: 19/126,807

(22) PCT Filed: Nov. 3, 2023
(86) PCT No.: PCT/US2023/078640

§ 371 Date: May 2, 2025

Related U.S. Application Data
(60) Provisional application No. 63/382,203, filed on Nov. 3, 2022.

(51) Int. Cl. C25C 1/20; B01J 20/32; B01J 20/34

(52) U.S. Cl. CPC C25C 1/20; B01J 20/3204; B01J 20/3219; B01J 20/3253; B01J 20/3433; B01J 20/3475

(57) ABSTRACT

Provided are methods for the capture of energy critical high value metals and an apparatus or system for an electrochemical approach to produce Ca- and Mg-hydroxides, silica, and leach metals into the solution phase that can be sequentially recovered. The methods entail: providing a functionalized sorbent for metal capture; recovering the metal from the metal-containing solution by contacting the functionalized sorbent with the metal-containing solution, thereby adsorbing metal ions from the metal-containing solution onto the functionalized sorbent; and desorbing the metal ions from the functionalized sorbent by contacting the functionalized sorbent with a stripping agent, thereby forming a stripped solution containing the metal ions.

### CROSS REFERENCE TO RELATED APPLICATIONS

This application is a U.S. National Phase filing under 35 U.S.C. § 371 of International Application PCT/US2023/078640, filed Nov. 3, 2023, and published as WO 2024/097961 A1 on May 10, 2024. PCT/US2023/078640 claims priority to U.S. Provisional Application No. 63/382,203, filed on Nov. 3, 2022, the entire contents of which are hereby incorporated by reference herein.

### GOVERNMENT LICENSE RIGHTS

This invention was made with government support under DE-EE0009391 and DE-AR0001608 awarded by the U.S. Department of Energy, and 2141091 awarded by the National Science Foundation. The government has certain rights in the invention.

### TECHNICAL FIELD

The present invention relates generally to the recovery of energy critical high value metals using functionalized materials. Also described herein are apparatus/systems for the electrochemical recovery of high value metals from functionalized materials.

### BACKGROUND

Energy critical metals, e.g., Pt, Pd, Ni, Mn, Co, Cu, Fe, etc., are highly valuable resources in renewable clean energy technologies. However, challenges exist in the recovery and recycling of such metals via solution mining. Traditionally, liquid-liquid separation approaches requiring organics, e.g., kerosene, are used for the recovery of energy critical metals. However, such organics are not environmentally benign. Thus, a need remains for improved metal capture methods.

Additionally, large quantities of naturally occurring silicate minerals, ores, and alkaline industrial residues are essential for the long-term durable storage of CO2 as solid carbonates. High temperatures exceeding 100° C. and CO2 partial pressures greater than 20 bar are typically needed to convert naturally occurring silicate minerals into their respective solid carbonates. The resulting materials often contain carbonate and siliceous materials. Thus, a need exists for alternative approaches.

### SUMMARY

The present invention provides for improved methods for the capture of energy critical high value metals and an apparatus/system for an electrochemical approach to produce Ca- and Mg-hydroxides, silica, and leach metals into the solution phase that can be sequentially recovered.

The need for improved metal capture methods is addressed herein through certain embodiments that eliminate the use of liquid-liquid separation approaches requiring organics (e.g., kerosene) that are not environmentally benign. In some embodiments, highly selective separation pathways are designed for effective metal recovery at concentrations ranging from, e.g., tens to thousands of ppm. In some embodiments, functionalized sorbents are used for metal capture. In some embodiments, the functionalized sorbents are regenerated using an acid swing. Acidic solutions generated during the electroplating of metals are used for sorbent regeneration. Furthermore, in various embodiments, these separation pathways are compatible with the compositions of the solutions recovered from the subsurface environments bearing CO₂ and with wide pH, including, but not limited to, in the range of 3-5. Thus, differentiated separation technologies need to be developed to be compatible with solution mining.

Another challenge is the need to develop technologies that can be easily adapted based on the mineralogy of the target geologic formations. For example, some geologic reservoirs contain Ni and Fe co-present with olivine, while those of other interests can contain Pt in addition to Ni, Co, Cu, Fe, Mn in ultramafic rocks. In some embodiments, the solution recovered after the separation of energy critical metals will contain Mg²⁺ ions and the ligands for metal extraction (e.g., PDTA) that are returned to the subsurface environment for carbon mineralization and energy critical metal recovery, respectively. To realize this transformative concept, embodiments of the approach to synthesize the materials for metal recovery and enhance metal recovery are described below.

In an aspect, provided is a method of recovering metal from a metal-containing solution, including:
providing a functionalized sorbent for metal capture;
recovering the metal from the metal-containing solution by contacting the functionalized sorbent with the metal-containing solution, thereby adsorbing metal ions from the metal-containing solution onto the functionalized sorbent; and
desorbing the metal ions from the functionalized sorbent by contacting the functionalized sorbent with a stripping agent, thereby forming a stripped solution containing the metal ions.

In some embodiments, the method further includes, after desorbing, electrodepositing the metal ions from the stripped solution containing metal ions onto a substrate, thereby separating the metal ions from the solution, and forming a stripped solution.

In an aspect, provided is a ligand, Si-M-VIL, of formula:

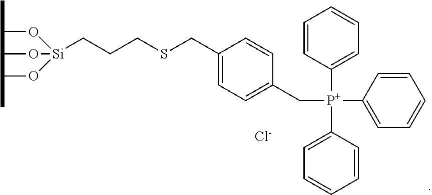 [SMILES: C[C@@H]1O[Si]2(CCCSCc3ccc(C[P+](c4ccccc4)(c4ccccc4)c4ccccc4)cc3)O[C@@H]1[C@@H](C)O2 ; [Cl-]]

In some embodiments, the ligand Si-M-VIL selectively captures platinum (Pt).

In an aspect, provided is an electroactive surface having one or more ligands tethered thereon, said surface being, due to the one or more ligands, highly selective for electrochemical adsorption and desorption from metal bearing solutions.

In an aspect, provided is a method for electrochemically recovering metal from a metal-containing solution, including:
providing a working electrode, the working electrode including a functionalized sorbent for metal capture;
capturing the metal from the metal-containing solution onto the functionalized sorbent at a negative potential; and
releasing the metal from the functionalized sorbent at a positive potential, thereby regenerating the working electrode.

In some embodiments, the functionalized sorbent includes a substrate, a redox active ligand, and a linker, wherein the linker tethers the redox active ligand to the substrate. In some embodiments, the functionalized sorbent is selected from Si-A₂-NB, Si-AEPTS-ARS, and Si-M-VF.

In an aspect, provided is an apparatus or system for producing one or more metal hydroxides, including:
a first chamber comprising an anode;
a second chamber comprising a cathode;
a conduit connecting the first chamber and the second chamber;
optionally a separator (e.g., a membrane) configured to separate the anode and cathode (e.g., placed in the conduit);
an electrolyte comprising a solvent and optionally one or more additives; and
one or more metal-bearing siliceous materials positioned inside the first chamber and optionally close to the anode, wherein at least part of the one or more metal-bearing siliceous materials are dissolved in the solvent/electrolyte, and one or more products are produced under an applied voltage for a time period, wherein the one or more products are selected from one or more metal hydroxides, silica, one or more metal ion dissolved in the solvent/electrolyte, hydrogen, oxygen, optionally one or more metal carbonates, optionally one or more metal oxides, or any combination thereof.

In some embodiments, the apparatus or system further includes:
a first filter or membrane positioned between the first chamber and a first end of the conduit; and
optionally a second filter or membrane positioned between the second chamber and a second end of the conduit,
wherein the first filter or membrane is configured to prevent the one or more metal-bearing siliceous materials from diffusing to the conduit from the first chamber and wherein the second filter or membrane is configured to prevent the one or more products from diffusing to the second chamber from the conduit.

In some embodiments of the apparatus or system, the one or more products includes;
one or more metal hydroxides accumulated substantially on the lower half of the conduit;
a silica material accumulated substantially on the lower half of the first chamber;
oxygen accumulated substantially at the upper half of the first chamber;
hydrogen accumulated substantially at the upper half of the second chamber;
optionally one or more dissolved metal ions primarily concentrated in the first chamber converted from the one or more metal-bearing siliceous materials; and
optionally one or more metal carbonates, hydroxides, and/or oxides accumulated substantially on the lower half of the conduit or on the lower half of the second chamber;
or any combination thereof.

In an aspect, provided is a method of producing one or more metal hydroxide, oxide, and/or carbonate compounds including:
providing an apparatus comprising an anode, a cathode, a liquid electrolyte, and optionally a separator membrane between the anode and the cathode:
providing one or more precursor compounds comprising one or more metal-bearing siliceous materials wherein the one or more precursor compounds are substantially insoluble in the liquid electrolyte and located in a first location;
applying a voltage between the anode and the cathode;
dissolving at least part of the one or more precursor compounds to form one or more soluble metal ions diffused in at least part of the liquid electrolyte;
accumulating one or more metal hydroxide, oxide, and/or carbonate compounds substantially in a second location different from the first location, wherein the one or more metal hydroxide, oxide, and/or carbonate compounds are substantially insoluble in water or in the liquid electrolyte (or have a low solubility of less than 1 g/100 ml (e.g., less than 0.5 g/ml) in water or less than 1 g/100 ml (e.g., less than 0.5 g/ml) in the liquid electrolyte).

These and other objects, features, and advantages of this invention will become apparent from the following detailed description of the various aspects of the invention taken in conjunction with the accompanying drawings.

### BRIEF DESCRIPTION OF THE FIGURES

FIG. 1 depicts a schematic representation of examples of the different modes of metal recovery.

FIG. 2 depicts an example workflow of the energy critical metal recovery platform using functional materials as described herein, wherein the resulting Mg-rich and ligand-bearing solution is for subsurface reinjection.

FIG. 3 depicts graphs of the extraction efficiency of energy critical metals (e.g., Ni(II), Cu(II), Co(II), Pt(II), Mg(II), etc.) using functional materials as described herein.

FIG. 4 depicts an example workflow of the energy critical metal recovery platform using functional materials as described herein and further Ca- and Mg-hydroxide formation.

FIG. 5 shows metals from the periodic table of the elements.

FIG. 6 depicts a map showing the availability of naturally occurring mineral deposits around the world.

FIG. 7 shows the reactivity of naturally occurring minerals at elevated temperatures and pressures to produce solid carbonates; a graph shows the extent of carbon mineralization (%) and cation content of the source material or rock (wt. %) (Ca—diamond, Mg—triangle, Fe—square, and Total—circle) for, from left to right (with reaction time following in parenthesis), basalt (5.0 h), anorthite (6.0 h), basalt (6.0 h), anorthosite (0.5 h), augite (1.0 h), lizardite (5.0 h), antigorite (6.0 h), olivine (5.0 h), forsterite (1.0 h), and wollastonite (1.0 h).

FIG. 8 depicts a schematic of the synthesis of Si-A₂-NB.

FIG. 9 depicts a schematic of the synthesis of Si-AEPTS-ARS.

FIG. 10 depicts a schematic of the synthesis of Si-M-VF.

FIG. 11 depicts a schematic showing an example configuration of H-type cell and the electrochemical dissolution of Ca- and Mg-bearing siliceous materials to co-produce Ca- and Mg-hydroxides, H₂, and O₂.

FIGS. 12A-12C depict a schematic showing an example configuration of H-type cell (FIG. 12A) and intensity graphs evidencing the electrochemically induced formation of Mg(OH)₂ (FIG. 12B) and Ca(OH)₂+CaCO₃ (FIG. 12C).

FIGS. 13A-13C depict a schematic showing an example configuration of H-type cell (FIG. 13A) and graphs evidencing the electrochemical recovery of silica (FIG. 13B and FIG. 13C).

FIG. 14 depicts a schematic of electrochemical reactions that may occur in the process, e.g., electrochemical recovery of Ca- and Mg-hydroxides, silica, H₂, and O₂.

FIG. 15 depicts a graph showing an example of the overall energy input for the process.

FIG. 16 depicts a graph showing evidence of silica precipitation and Ca- and Mg-hydroxide formation based on x-ray diffraction (XRD) analysis.

FIGS. 17A and 17B depict graphs showing evidence of hydroxide formation based on Fourier transform infrared (FTIR) spectroscopy analysis (FIG. 17A) and derivative thermogravimetry (DTG) analysis (FIG. 17B).

FIG. 18 depicts a graph of the concentration of metals in the anode and cathode chambers.

FIG. 19 depicts mesoporous silica functionalization validation (Si-A₂-NB) through spectral analysis.

FIGS. 20A and 20B depict graphs of pore size and surface modification (FIG. 20A), and thermal stability (FIG. 20B) of functionalized mesoporous silica (Si-A₂-NB).

FIGS. 21A and 21B depict the morphology (FIG. 21A) and size distribution (FIG. 21B) of mesoporous silica (Si-A₂-NB).

FIGS. 22A and 22B depict graphs of the pH swing approach for Zn recovery (FIG. 22A) and selectivity of competitive metal ions (FIG. 22B).

FIGS. 23A and 23B depict the Langmuir (FIG. 23A) and Freundlich (FIG. 23B) fitted models for adsorption isotherm of metal uptake from Zn, Ni, Co, and Cu mixture within 3 hours.

FIGS. 24A-24C depict graphs of kinetic data (FIG. 24A), pseudo-first order (FIG. 24B) and pseudo-second order (FIG. 24C) models for the metal adsorption.

FIGS. 25A and 25B depict graphs of the metal uptake and release (FIG. 25A), regeneration (FIG. 25B) of functionalized silica from Zn, Ni, Co, Cu mixture.

FIGS. 26A and 26B depict cyclic voltammetry diagrams of Si-A₂-NB showing redox activity (FIG. 26A) and effect on redox activity under influence of various metal solutions (FIG. 26B).

FIG. 27 depicts a graph of a potential scan for 1 h showing metal uptake at different potentials.

FIG. 28 depicts an illustration of redox active ligand and metal bond formation for uptake and release.

FIGS. 29A and 29B depict graphs of adsorption isotherm (FIG. 29A) and kinetics (FIG. 29B) for metal uptake from Zn, Ni, Co, and Cu mixture within 1 hour.

FIGS. 30A-30C depict graphs of kinetic data (FIG. 30A), pseudo-first order (FIG. 30B) and pseudo-second order (FIG. 30C) models for metal uptake from Zn, Ni, Co, and Cu mixture within 1 hour.

FIGS. 31A and 31B depict graphs of metal uptake (−0.3V) and release (+0.2V) (FIG. 31A), and regeneration (FIG. 31B) of functionalized silica from Zn, Ni, Co, and Cu mixture.

FIG. 32 depicts mesoporous silica functionalization validation (Si-AEPTS-ARS) through spectral analysis.

FIGS. 33A and 33B depict graphs of pore size and surface modification (FIG. 33A), and thermal stability (FIG. 33B) of functionalized mesoporous silica (Si-AEPTS-ARS).

FIG. 34 depicts a graph of the pH swing approach for Ag capture by Si-AEPTS-ARS.

FIG. 35 depicts a graph demonstrating the selective uptake of Ag by Si-AEPTS-ARS.

FIGS. 36A and 36B depict graphs of the selectivity (FIG. 36A), desorption and regeneration (FIG. 36B) of functionalized silica of Ag from the mixture of 100 ppm Ag, Au, Pd, and Pt.

FIGS. 37A and 37B depict graphs demonstrating tethering on SBA15 by FTIR (FIG. 37A) and thermal stability by TGA (FIG. 37B) for functionalized mesoporous silica (Si-M-VF).

FIGS. 38A and 38B depict graphs of pore size surface coverage by BET analyzer and particle size analysis by PSA for functionalized mesoporous silica (Si-M-VF).

### DETAILED DESCRIPTION

In the following and attached description, reference is made to the accompanying drawings and text that form a part hereof, and in which is shown by way of illustration specific embodiments which may be practiced. These embodiments are described in detail to enable those skilled in the art to practice the invention, and it is to be understood that other embodiments may be utilized, and that structural, logical and electrical changes may be made without departing from the scope of the present invention. The following and attached description of example embodiments is, therefore, not to be taken in a limited sense, and the scope of the present invention is defined by the appended claims.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this application, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

The terminology used herein is standard terminology in the art and is used as understood by persons of skill in the art.

In an aspect, provided is a method of recovering metal from a metal-containing solution, including:
providing a functionalized sorbent for metal capture;
recovering the metal from the metal-containing solution by contacting the functionalized sorbent with the metal-containing solution, thereby adsorbing metal ions from the metal-containing solution onto the functionalized sorbent; and
desorbing the metal ions from the functionalized sorbent by contacting the functionalized sorbent with a stripping agent, thereby forming a stripped solution containing the metal ions.

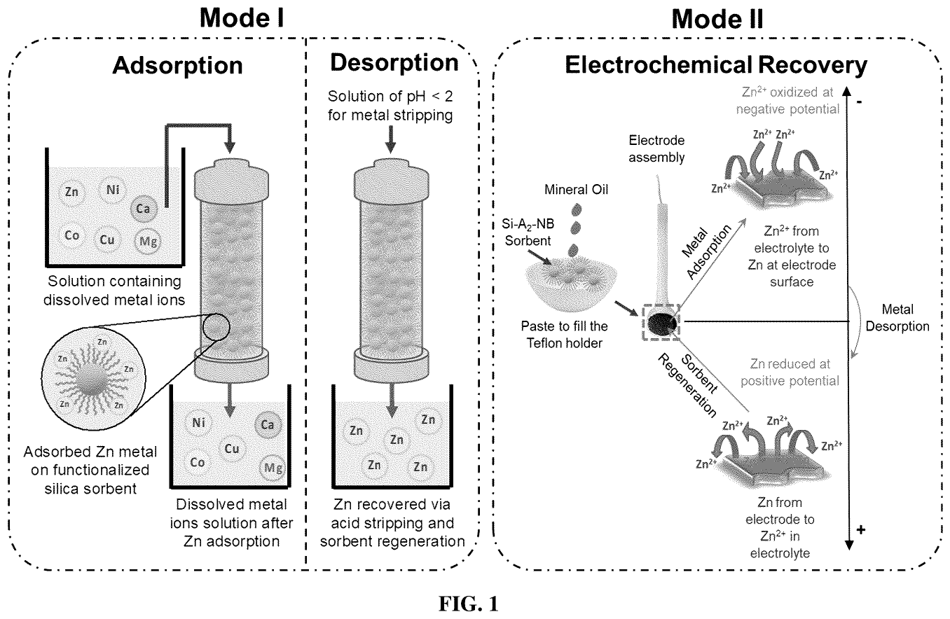

In some embodiments, providing a functionalized sorbent for metal capture includes providing, e.g., synthesizing, one or more ligands for selective metal capture and functionalizing the one or more ligands onto the sorbent, e.g., solid interface, for metal capture using pH swing or electrochemical swing, such that the ligand is tethered to the sorbent for direct use in liquid-liquid separation. A schematic representation of examples of the different modes of metal recovery (e.g., pH swing and electrochemical swing) is shown in FIG. 1. For example, the schematic shows the recovery of Zn by pH swing (mode 1) and electrochemical swing (mode 2).

In some embodiments, said recovering and/or desorbing are performed in chemical environment. In some embodiments, said recovering and/or desorbing are performed in electrochemical environment.

In some embodiments, the method further includes, after said desorbing, electrodepositing the metal ions from the stripped solution onto a substrate, thereby separating the metal ions from the solution, and forming a stripped solution.

In some embodiments, the electrodepositing includes:
regulating pH of the stripped solution (e.g., from about −2 pH to about 9.5 pH (e.g., −2.0, −1.9, −1.8, −1.7, −1.6, −1.5, −1.4, −1.3, −1.2, −1.1, −1.0, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, or 9.5 pH, including any and all range and subranges therein) to optimize electrodeposition of the metal from the stripped solution;
optionally adding an appropriate electrolyte to enhance conductivity of the stripped solution for electroplating;
contacting the stripped solution with an anode and a cathode;
applying a voltage to the anode and cathode to achieve a desired current density, thereby depositing a layer of the metal on the cathode;
removing the cathode; and
isolating the metal from the cathode.

In some embodiments, isolating the metal from the cathode includes washing the cathode, e.g., with DI water, drying the cathode, e.g., in an oven, and scraping the metal from the cathode surface.

In some embodiments, the cathode is a substrate having a metallic surface.

In some embodiments of the invention, the metal comprises a base metal. In some embodiments, the base metal is selected from nickel (Ni), cobalt (Co), zinc (Zn), and manganese (Mn).

In some embodiments, the metal comprises a platinum-group metal (PGE) selected from ruthenium (Ru), rhodium (Rh), palladium (Pd), osmium (Os), iridium (Ir), and platinum (Pt).

In some embodiments, the metal is one or more of Pt, Pd, Ni, Mn, Co, copper (Cu), or iron (Fe).

In some embodiments, the metal comprises a rare earth group metal (REE) selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) ytterbium (Yb), lutetium (Lu), scandium (Sc), and yttrium (Y).

In some embodiments, the current density is −1000 mA/cm² to 1000 mA/cm² (e.g., +10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 (wherein each number is intended to be recited in both the positive and negative)), including any and all ranges and subranges therein.

In some embodiments, the metal-containing solution contains a molar concentration (mol/L) of metal of 0.005 to 1 M (for example, 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, or 1.0 M, including any and all ranges and subranges therein (e.g., 0.005 to 0.04 M, 0.01 to 0.03 M, etc.)).

In some embodiments, the metal-containing solution contains 10 to 100,000 ppm of the metal (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, or 100000), including any and all ranges and subranges therein.

In some embodiments, the metal-containing solution is an aqueous solution having therein:
a concentration of calcium (Ca) ions (Ca²⁺) of from about 100 mg/L to about 1500 mg/L (for example, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, or 1500 mg/L), including any and all ranges and subranges therein (e.g., 300 mg/L to 1500 mg/L, 400 mg/L to 1500 mg/L, 400 mg/L to 1400 mg/L, etc.); and/or
a concentration of magnesium (Mg) ions (Mg²⁺) of from about 100 mg/L to about 1500 mg/L (for example, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, or 1500 mg/L), including any and all ranges and subranges therein (e.g., 300 mg/L to 1500 mg/L, 400 mg/L to 1500 mg/L, 400 mg/L to 1400 mg/L, etc.)

In some embodiments, the functionalized sorbent is functionalized silica.

In some embodiments, the functionalized silica is selected from Si-M (e.g., —SH functionalized silica), Si-M-VIL (e.g., monomer ionic liquid functionalized silica), Si-M-PolyIL (polymer ionic liquid functionalized silica), Si-A3 (e.g., AEPTS functionalized silica), Si-AC (e.g., —COOH functionalized silica), Fe-imprinted thiocyanato FS (e.g., —SCN functionalized silica), Si-TBP (e.g., TBP functionalized silica), Si-Cnx302 (e.g., cyanex 302 functionalized silica), and Si-UPTS (e.g., UPTS functionalized silica).

In some embodiments, the functionalized sorbent comprises mesoporous silica with ordered porosity (e.g., MCM-41 or SBA-15).

In some embodiments, the functionalized sorbent has selective binding affinity for one or more specific metals.

In some embodiments, the metal (e.g., Pt, Cu, etc.) is recovered at lower pH conditions, such as about 1 pH or lower, including all ranges and subranges therein, e.g., about 0 pH or lower, about −1 pH or lower, about −2 pH to about −1 pH, about −1 pH to about 0 pH, about 0 pH to about 1 pH, about 1 pH, about 0 pH, about −1 pH, and about −2 pH, etc.

In some embodiments, the metal (e.g., Fe, Co, Ni Mn, etc.) is recovered at about 4 to about 5 pH, including all ranges and subranges therein, e.g., about 4 pH, about 4.1 pH, about 4.2 pH, about 4.3 pH, about 4.4 pH, about 4.5 pH, about 4.6 pH, about 4.7 pH, about 4.8 pH, about 4.9 pH, and about 5.0 pH, etc.

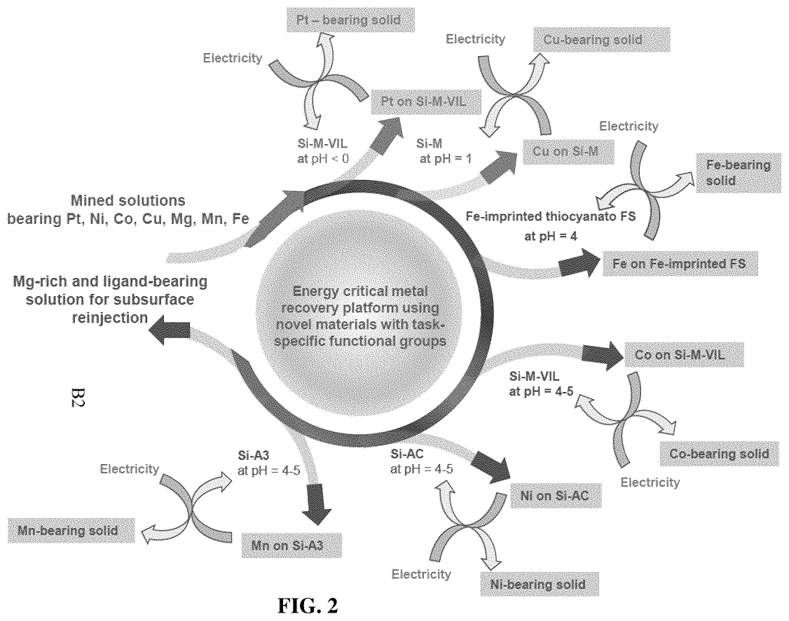

A non-limiting example workflow of the energy critical metal recovery platform using functional materials is shown in FIG. 2. For example, the mined metal-containing solution may contain Pt, Ni, Co, Cu, Mg, Mn, and Fe. Further, Pt may be selectively recovered using Si-M-VIL at pH less than 0, Cu may be selectively recovered using Si-M at pH 1, Fe may be selectively recovered using Fe-imprinted FS at pH 4, Co may be selectively recovered using Si-M-VIL at pH 4-5, Ni may be selectively recovered using Si-AC at pH 4-5, and Mn may be selectively recovered using Si-A3 at pH 4-5. Moreover, after selective recovery of the metals, the resulting solution may be a Mg-rich and ligand-bearing solution for subsurface reinjection.

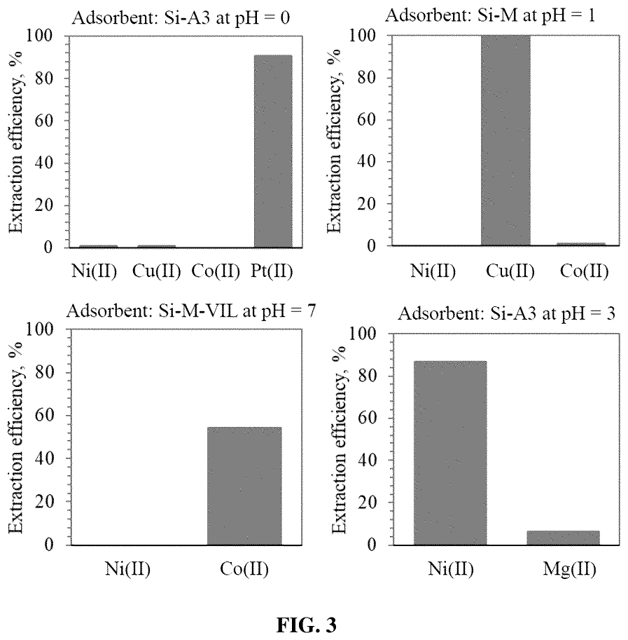

Now referring to FIG. 3, the Si-A3 adsorbent at pH 0 efficiently and selectively captures Pt(II), the Si-M adsorbent at pH 1 efficiently and selectively captures Cu(II), the Si-M-VIL adsorbent at pH 7 selectively and relatively efficiently captures Co(II), and the Si-A3 adsorbent at pH 3 efficiently and selectively captures Ni(II).

The stripping agent may be any agent capable of desorbing the metal ions from the spent functionalized sorbent. In some embodiments, the stripping agent includes an inorganic acid. Inorganic acids are known to those skilled in the art. Non-limiting examples of inorganic acids include hydrochloric acid (HCl), sulfuric acid (H₂SO₄), nitric acid (HNO₃), etc. In some embodiments, the stripping agent further includes thiourea, e.g., thiourea in HCl, or ascorbic acid, e.g., ascorbic acid and HCl. In some embodiments, the stripping agent is selected from thiourea in HCl, HCl, 1-3 M HCl, H₂SO₄, 0.3 M HCl, and 0.5 M HCl+ascorbic acid. In some embodiments, the stripping agent is 0.1-4 M HCl (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0 M HCl).

In some embodiments, one or more method steps are performed at a temperature of 20° C. to 110° C. (e.g., 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, or 110° C.), including any and all ranges and subranges therein.

In some embodiments, the inventive method has an extraction efficiency of greater than 80% (e.g., greater than 80, 81, 82, 83, 84, 85, 86, 87, 88, 89, 90, 91, 92, 93, 94, 95, 96, 97, 98, 99, 99.5, or 99.9%). In some the embodiments, the inventive method has an extraction efficiency of 100%.

In some the embodiments, the inventive method has an extraction efficiency of 80-100% (e.g., 80, 81, 82, 83, 84, 85, 86, 87, 88, 89, 90, 91, 92, 93, 94, 95, 96, 97, 98, 99, 99.5, 99.9, or 100%), including any and all ranges and subranges therein.

In an aspect, the invention provides a ligand which is Si-M-VIL of formula:

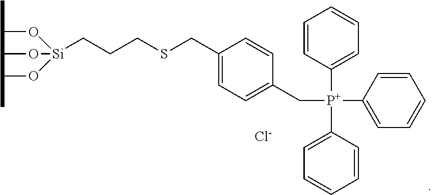 [SMILES: C[C@@H]1O[Si]2(CCCSCc3ccc(C[P+](c4ccccc4)(c4ccccc4)c4ccccc4)cc3)O[C@@H]1[C@@H](C)O2 ; [Cl-]]

In some embodiments, the ligand Si-M-VIL is used for selectively recovering platinum (Pt).

In some embodiments, the solution recovered after separation of energy critical metals may contain Mg² ions and the ligands for metal extraction (e.g., PDTA) that are returned to the subsurface environment for carbon mineralization and energy critical metal recovery, respectively.

In some embodiments, selective recovery of one or more metals occurs alongside carbon mineralization of Mg and/or Ca. For example, the primary and secondary bioleaching of the tailings may comprise one or more Fe, Ni, Co, and Cr. Traditional liquid-liquid separation methods employ hazardous organics, e.g., kerosene. An alternative to conventional pyrometallurgical and hydrometallurgical pathways innovative CO₂-based hydrometallurgical approaches harness renewable energy.

Now referring to FIG. 4, a non-limiting example of an integrated separation scheme for energy-critical metal recovery is shown. For example, the metal-containing solution may be a biomining solution bearing Fe²⁺/Fe³⁺, Co²⁺, Cr²⁺/Cr³⁺, Ni²⁺, and Mg²⁺ ions. In some embodiments, Fe may be selectively captured using Si-TBP at about pH less than 0. In some embodiments, Co may be selectively captured using Si-Cnx302 at about pH 2. In some embodiments, Cr may be selectively captured using Si-UPTS at about pH 7. In some embodiments, Ni may be selectively captured using Si-AC at about pH 8. In some embodiments, electricity may be applied to the Mg- and Ca-rich solution to yield high purity CO₂, Mg carbonate, and Ca carbonate. In some embodiments, the resulting CO₂-loaded regenerable solvents are regenerated for further CO₂ capture. In some embodiments, the final metal-lean solution may be used for water treatment and further reuse.

In some embodiments, pH swing is used to regenerate sorbents by harnessing acids generated using electroplating of metals.

Metals recovered at lower pH conditions, e.g., pH of about 1 or less, including any and all ranges, subranges, and values therein (e.g., about −2 pH to about 1 pH, about −2 pH to about 0 pH, about −2 pH to about −1 pH, about −1 pH to about 1 pH, about −1 pH to about 0 pH, about 0 pH to about 1 pH, about −2 pH, about −1 pH, about 0 pH, about 1 pH, etc.), may include Fe.

Metals recovered at higher pH conditions, e.g., pH of about 2 to about 8, including any and all ranges, subranges, and values therein (e.g., about 2 pH, about 2.5 pH, about 3 pH, about 3.5 pH, about 4 pH, about 4.5 pH, about 5 pH, about 5.5 pH, about 6 pH, about 6.5 pH, about 7 pH, about 7.5 pH, about 8 pH, etc.), may include Co, Cr, Ni.

In some embodiments, Ni is electroplated in the presence of CO₂-bearing flue gas streams to co-produce high purity CO₂ and pure Ni metal using regenerable CO₂ capture solvents. The high purity CO₂ stream may then be used for precipitating Mg- and Ca-carbonate.

In some embodiments, the amount of Mg and Ca may be the same as or several orders of magnitude higher than that of Ni.

In an aspect, provided is an electroactive surface having one or more ligands tethered thereon, said surface being, due to the one or more ligands, highly selective for electrochemical adsorption and desorption from metal bearing solutions.

In some embodiments, an electrochemical swing approach is used, wherein redox active ligands are tethered to silica surfaces for selective capture of metals.

In an aspect, provided is a method for electrochemically recovering metal from a metal-containing solution, including:
providing a functionalized sorbent for metal capture;
capturing the metal from the metal-containing solution onto the functionalized sorbent at negative potential; and
releasing the metal from the functionalized sorbent at positive potential, thereby regenerating the working electrode.

In some embodiments of the method for electrochemically recovering metal from a metal-containing solution, the functionalized sorbent includes a substrate, a redox active ligand, and a linker, wherein the linker tethers the redox active ligand to the substrate.

In some embodiments of the method for electrochemically recovering metal from a metal-containing solution, the substrate is a siliceous material. In some embodiments, the substrate is a mesoporous silica.

In some embodiments of the method for electrochemically recovering metal from a metal-containing solution, the redox active ligand is selected from Nile Blue (NB), 3,4-Dihydroxy-9,10-dioxo-9,10-dihydroanthracene-2-sulfonic acid (Alizarin Red S; ARS), and vinyl-ferrocene (VF).

In some embodiments of the method for electrochemically recovering metal from a metal-containing solution, the linker is selected from 3-(2-aminoethylamino) propyltrimethoxysilane (A₂), 3-(aminopropyl)triethoxy silane (AEPTS), and 3-mercaptopropyl trimethoxysilane (M).

In some embodiments of the method for electrochemically recovering metal from a metal-containing solution, the functionalized sorbent is selected from Si-A₂-NB, Si-AEPTS-ARS, and Si-M-VF.

In some embodiments, a three-electrode system is used to electrochemically recover metal from a metal-containing solution. For example, the three-electrode system may comprise a first electrode, e.g., a working electrode, a second electrode, e.g., a reference electrode, and a third electrode, e.g., a supporting/counter/auxiliary electrode. In some embodiments, the working electrode comprises a working electrode body and the functionalized material. For example, the working electrode body may be a tube, e.g., a Teflon tube. In some embodiments, a paste comprising the functionalized material is prepared. For example, the functionalized material may be mixed with mineral oil to form a fine paste. In some embodiments, the functionalized material (e.g., the paste) is packed into the working electrode body (e.g., the tube). In some embodiments, electrical contact is established, for example, by placing a copper wire through the center of the working electrode body (e.g., the tube). In some embodiments, the surface of the working electrode is scrubbed against a bond paper until the surface is smooth. In some embodiments, potentiostate is used. In some embodiments, the three-electrode system comprises a supporting electrolyte. In some embodiments, the electrolyte comprises a solvent and optionally one or more additives.

In a non-limiting example, the working electrode comprises a paste of Si-A₂-NB, the reference electrode comprises Ag/AgCl (saturated with 3 M KCl), and the counter electrode comprises a platinum mesh. In a non-limiting example, the supporting electrolyte is 0.5 M NaCl (about pH 5).

In some embodiments, capturing the metal from the metal-containing solution onto the functionalized sorbent at negative potential comprises applying a negative potential for at least 15 minutes, including any and all ranges, subranges, and values therein, e.g., at least 15, 20, 25, 30, 35, 40 45, 50, or 55 minutes, or at least 1, 2, 3, 4, 5, 6, 7, 8, 9, 10, 11, 12, 13, 14, 15, 16, 17, 18, 19, 20, 21, 22, 23, or 24 hours. In some embodiments, the negative potential is applied for up to 1 hour, e.g., for about 0 to about 60 minutes. In some embodiments, the negative potential is constant.

In some embodiments, releasing the metal from the functionalized sorbent at positive potential, thereby regenerating the working electrode, comprises applying a positive potential for at least 15 minutes, including any and all ranges, subranges, and values therein, e.g., at least 15, 20, 25, 30, 35, 40 45, 50, or 55 minutes, or at least 1, 2, 3, 4, 5, 6, 7, 8, 9, 10, 11, 12, 13, 14, 15, 16, 17, 18, 19, 20, 21, 22, 23, or 24 hours. In some embodiments, the positive potential is applied for up to 1 hour, e.g., for about 0 to about 60 minutes. In some embodiments, the positive potential is constant.

In some embodiments, the working electrode is reduced to neutralize the positive charge and reuse for cation adsorption. In some embodiments, electrode reduction occurs by chronopotentiometry with an applied current of about-0.025 mA.

In some embodiments of the method for electrochemically recovering metal from a metal-containing solution, the metal-containing solution comprises one or more metals. For example, the one or more metals may be any metal or combination of metals in the periodic table of elements.

In some embodiments, the one or more metals are selected from a base metal. In some embodiments, the base metal is selected from Ni, Co, Zn, and Mn.

In some embodiments, the one or more metals are selected from one or more transition metals. Non-limiting examples of transition metals include Zn, Ni, Co, Cu, Au, Ag, Pd, Pt, La, Ni etc.

In some embodiments, the one or more metals are selected from one or more platinum-group metals (PGE). PGE metals include ruthenium (Ru), rhodium (Rh), palladium (Pd), osmium (Os), iridium (Ir), and platinum (Pt).

In some embodiments, the one or more metals are selected from one or more rare earth group metal (REE). REE metals include lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) ytterbium (Yb), lutetium (Lu), scandium (Sc), and yttrium (Y).

In some embodiments of the method for electrochemically recovering metal from a metal-containing solution, the current density is −1000 mA/cm² to 1000 mA/cm² (e.g., ±10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 (wherein each number is intended to be recited in both the positive and negative)), including any and all ranges and subranges therein.

In some embodiments of the method for electrochemically recovering metal from a metal-containing solution, the metal-containing solution contains a molar concentration (mol/L) of metal of 0.005 to 1 M (for example, 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, or 1.0 M, including any and all ranges and subranges therein (e.g., 0.005 to 0.04 M, 0.01 to 0.03 M, etc.)).

In some embodiments of the method for electrochemically recovering metal from a metal-containing solution, the metal-containing solution contains 10 to 100,000 ppm of the metal (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, or 100000), including any and all ranges and subranges therein.

In some embodiments of the method for electrochemically recovering metal from a metal-containing solution, the metal-containing solution is an aqueous solution having therein:
a concentration of calcium (Ca) ions (Ca²⁺) of from about 100 mg/L to about 1500 mg/L (for example, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, or 1500 mg/L), including any and all ranges and subranges therein (e.g., 300 mg/L to 1500 mg/L, 400 mg/L to 1500 mg/L, 400 mg/L to 1400 mg/L, etc.); and/or
a concentration of magnesium (Mg) ions (Mg²⁺) of from about 100 mg/L to about 1500 mg/L (for example, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, or 1500 mg/L), including any and all ranges and subranges therein (e.g., 300 mg/L to 1500 mg/L, 400 mg/L to 1500 mg/L, 400 mg/L to 1400 mg/L, etc.)

In an aspect, provided is an apparatus or system for producing one or more metal hydroxides, including:
a first chamber comprising an anode;
a second chamber comprising a cathode;
a conduit connecting the first chamber and the second chamber;
optionally a separator (e.g., a membrane) configured to separate the anode and cathode (e.g., placed in the conduit);
an electrolyte comprising a solvent and optionally one or more additives; and
one or more metal-bearing siliceous materials positioned inside the first chamber and optionally close to the anode, wherein at least part of the one or more metal-bearing siliceous materials are dissolved in the solvent/electrolyte, and one or more products are produced under an applied voltage for a time period, wherein the one or more products are selected from one or more metal hydroxides, silica, one or more metal ion dissolved in the solvent/electrolyte, hydrogen, oxygen, optionally one or more metal carbonates, optionally one or more metal oxides, or any combination thereof.

In some embodiments of the apparatus or system, the separator is a membrane. In some embodiments of the apparatus or system, the membrane is an ion exchange membrane. In some embodiments of the apparatus or system, the ion exchange membrane comprises organic, inorganic, or mixed and composite materials. In some embodiments of the apparatus or system, the membrane comprises Nafion.

In some embodiments of the apparatus or system, the electrolyte comprises a solvent. In some embodiments of the apparatus or system, the solvent comprises salts of group I metals. Non-limiting examples of salts of group I metals include potassium nitrate and sodium nitrate. In some embodiments of the apparatus or system, the solvent is water.

In some embodiments of the apparatus or system, the electrolyte further comprises one or more additives. In some embodiments of the apparatus or system, the one or more additives comprise one or more metal salts soluble in the solvents. Non-limiting examples of one or more metal salts soluble in the solvents include chlorides, sulfates, or nitrates of sodium, potassium calcium, or magnesium, or any combination thereof.

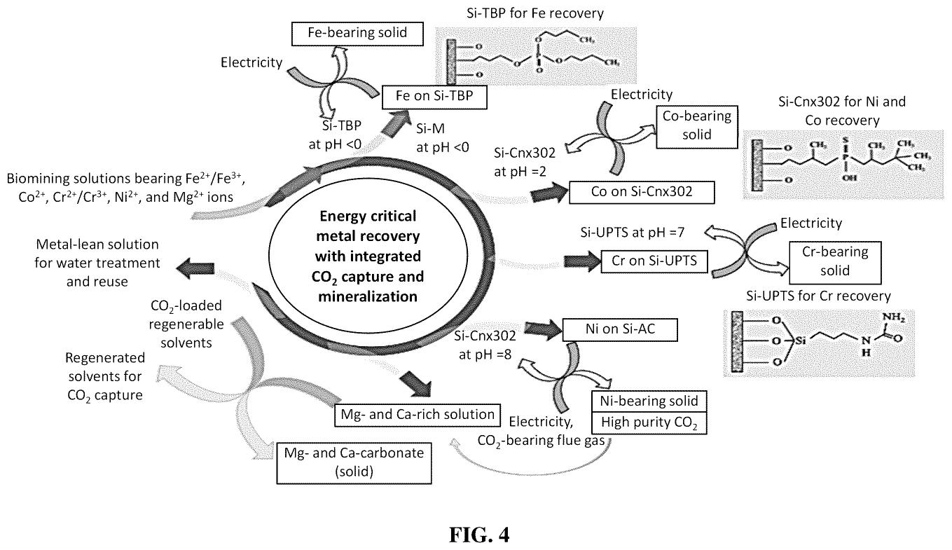

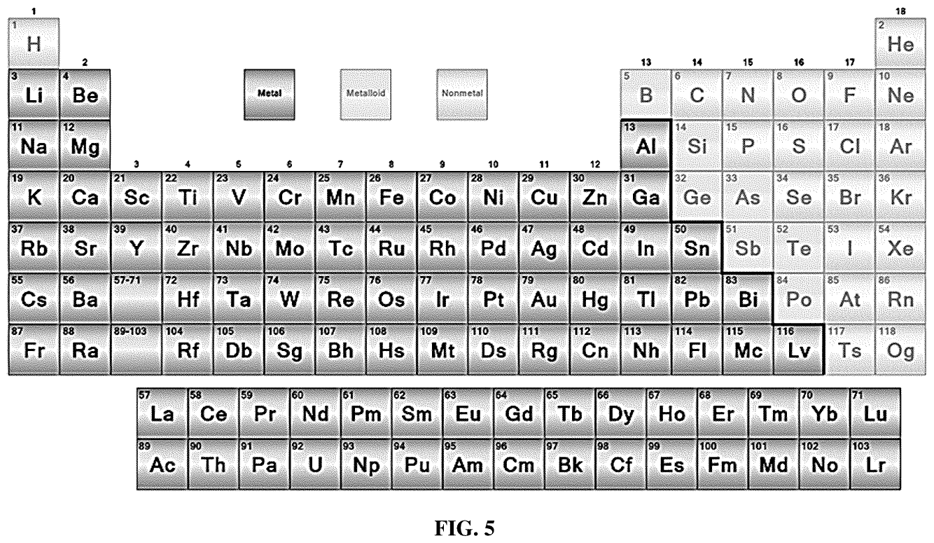

In some embodiments of the apparatus or system, the one or more metal-bearing siliceous materials comprise silica (SiO₂). In some embodiments of the apparatus or system, the one or more metal-bearing siliceous materials further comprise a metal. Metals from the periodic table are shown in FIG. 5.

In some embodiments of the apparatus or system, the metal is Ca, Mg, Al, Fe, Mn, Pb, Ni, Co, or Zn.

In some embodiments of the apparatus or system, the apparatus or system further comprises:
a first filter or membrane positioned between the first chamber and a first end of the conduit; and
optionally a second filter or membrane positioned between the second chamber and a second end of the conduit,
wherein the first filter or membrane is configured to prevent the one or more metal-bearing siliceous materials from diffusing to the conduit from the first chamber and wherein the second filter or membrane is configured to prevent the one or more products (e.g., one or more metal hydroxides) from diffusing to the second chamber from the conduit.

In some embodiments of the apparatus or system, the first chamber has an average pH that is acidic and the second chamber has an average pH that is basic during at least part of the operation process. A pH of 7 is neutral, a pH of less than 7 is acidic, and a pH of greater than 7 is basic. For example, an acidic pH is less than 7, including any and all ranges, subranges, and values therein, e.g., less than pH 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1, or 0, etc. For example, a basic pH is greater than 7, including any and all ranges, subranges, and values therein, e.g., greater than pH 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, or 14.9, etc.

In some embodiments of the apparatus or system, the first chamber has an average pH of less than 3 (or less than 2, 1, 0, or −1), for example, a pH of −2 to 2.9 (e.g., −2.0, −1.9, −1.8, −1.7, −1.6, −1.5, −1.4, −1.3, −1.2, −1.1, −1.0, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or 2.9), including any and all ranges and subranges therein, and the second chamber has an average pH of greater than 9 (or greater than 10, 11, 12, or 13), for example, a pH of 9.1 to 14 (e.g., 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, or 14.0), including any and all ranges and subranges therein, during at least part of the operation process.

In some embodiments of the apparatus or system, the one or more products comprising one or more metal hydroxides, optionally one or more metal oxides, accumulated in the conduit (e.g., located between the separator of the conduit and the second chamber) and/or the cathode chamber. In some embodiments of the apparatus or system, the one or more products comprising one or more metal hydroxides accumulated in the conduit (e.g., located between the separator of the conduit and the second chamber).

In some embodiments of the apparatus or system, the voltage is a DC voltage of at least 1.5 V, including any and all ranges, subranges, and values therein, e.g., at least 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, or 25 V, etc. For example, about 1.5 V to about 300 V, including any and all ranges, subranges, and values therein, e.g., about 1.5 V to about 5 V, about 5 V to about 10 V, about 10 V to about 15 V, about 15 V to about 20 V, etc. For example, about 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, or 25 V, etc. In some embodiments of the apparatus or system, the voltage is a DC voltage of at least 5 V (e.g., at least 5, 10, 15, or 20V), for example, 5-300 V (e.g., with any number therein or any subranges therebetween, preferably at least 10 V, 15 V, or 20V).

In some embodiments of the apparatus or system, the one or more metal-bearing siliceous materials are selected from a naturally occurring metal silicate, metal hydroxide, metal oxide, metal alloy, mixed metal material, ore, mineral, a slag material, a material comprising a calcium silicate and/or a magnesium silicate, carbonate-bearing solids, solutions and/or suspensions bearing metals, or any combination thereof. In some embodiments of the apparatus or system, the one or more metal-bearing siliceous materials are selected from a naturally occurring metal silicate, a slag material, a material comprising a calcium silicate and/or a magnesium silicate, carbonate-bearing solids, solutions and/or suspensions bearing metals, or any combination thereof.

In some embodiments of the apparatus or system, the metal-bearing siliceous material comprises materials that are acid-soluble. In some embodiments of the apparatus or system, the metal-bearing siliceous material comprises materials, ores, or minerals bearing calcium silicate, magnesium silicate, aluminum silicate, hydroxide, oxide, or carbonate, or any combination thereof. In some embodiments of the apparatus or system, the metal-bearing siliceous material comprises calcium silicate or magnesium silicate.

In some embodiments of the apparatus or system, the one or more additives comprise one or more metal salts soluble in the solvent/electrolyte (e.g., chlorides, sulfates, or nitrates of sodium, potassium calcium, or magnesium). In some embodiments of the apparatus or system, the solvent is conductive. In some embodiments of the apparatus or system, the solvent comprises water.

In some embodiments of the apparatus or system, the one or more products comprise:
one or more metal hydroxides accumulated substantially on the lower half of the conduit;
a silica material accumulated substantially on the lower half of the first chamber;
oxygen accumulated substantially at the upper half of the first chamber;
hydrogen accumulated substantially at the upper half of the second chamber;
optionally one or more dissolved metal ions primarily concentrated in the first chamber converted from the one or more metal-bearing siliceous materials; and
optionally one or more metal carbonates accumulated substantially on the lower half of the conduit or on the lower half of the second chamber;
or any combination thereof.

In some embodiments of the apparatus or system, the first filter and the second filter are individually selected from a paper filter or one or more layers of a porous material configured to prevent the diffusion of solid particles greater than a predetermined size and allow the diffusion of soluble metal ions.

In some embodiments of the apparatus or system, the conduit is a connecting tube between the first chamber (anode) and the second chamber (cathode). In some embodiments of the apparatus or system, the conduit comprises a polymer. In some embodiments of the apparatus or system, the conduit is a glass capillary tube.

In some embodiments of the apparatus or system, the conduit connects the lower half of the first chamber and the lower half of the second chamber.

In some embodiments of the apparatus or system, the conduit has a volume of at least 1.2 times (or two times, three times, or four times) greater than a predetermined volume of the one or more metal hydroxides products (e.g., calculated from the input precursor materials and an expected conversion rate).

In some embodiments of the apparatus or system, at least 1% of the one or more metal-bearing siliceous materials are dissolved, including any and all ranges, subranges, and values therein, e.g., at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, or 42%. In some embodiments of the apparatus or system, at least 10%, at least 15% (e.g., at least 15, 16, 17, 18, 19, 20, 21, 22, 23, 24, 25, 26, 27, 28, 29, 30, 31, or 32%) of the one or more metal-bearing siliceous materials are dissolved.

In some embodiments of the apparatus or system, the recovery rate of the silica is at least 1%, including any and all ranges, subranges, and values therein, e.g., at least 1, 1.2, 2.2, 2.3, 2.4, 2.5, 2.6 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99%, wherein the recovery rate of the silica is calculated by wt. %=wt. (SiO2)/(wt. (SiO2)+wt. (metal silicate)) at the end of a reaction. In some embodiments of the apparatus or system, the recovery rate of the silica is at least 2.1% (e.g., at least 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99%), wherein the recovery rate of the silica is calculated by wt. %=wt. (SiO2)/(wt. (SiO2)+wt. (metal silicate)) at the end of a reaction.

In some embodiments of the apparatus or system, the time period is at least 15 minutes, including any and all ranges, subranges, and values therein, e.g., at least 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes, or at least 1, 2, 3, 4, 5, 6, 7, 8, 9, 10, 11, 12, 13, 14, 15, 16, 17, 18, 19, 20, 21, 22, 23, or 24 hours, etc. In some embodiments of the apparatus or system, the time period is at least 1 hour (e.g., at least 1, 2, 3, 4, 5, 6, 7, 8, 9, 10, 11, 12, 13, 14, 15, 16, 17, 18, 19, 20, 21, 22, 23, or 24 hours). In some embodiments, the time period is 1-48 hours (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, or 48 hours), including any and all ranges and subranges therein.

In some embodiments of the apparatus or system, the one or more metal hydroxide products, or one or more metal oxides products, have a purity of greater than 1%, including any and all ranges, subranges, and values therein, e.g., greater than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99%), based on the total weight of the product. In some embodiments of the apparatus or system, the one or more metal hydroxide products have a purity of greater than 60% (e.g., greater than 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99%), based on the total weight of the product.

In some embodiments at least one of the one or more metal hydroxides products, or one or more metal oxides products, have metal hydroxide(s), or metal oxide(s) content of greater than 70% by weight (e.g., greater than 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99%). In some embodiments at least one of the one or more metal hydroxides products have metal hydroxide(s) content of greater than 70% by weight (e.g., greater than 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99%).

Some embodiments of the apparatus or system further comprise recovering one or more dissolved metal ions by adding a reagent (e.g., carbon dioxide, CO₂) configured to react with the one or more dissolved metal ions to form one or more insoluble materials.

In some embodiments of the apparatus or system, the one or more metal-bearing siliceous materials are disposed in a first location and the one or more metal hydroxides are accumulated in a second location different from the first location.

In some embodiments of the apparatus or system, the silica is accumulated in a first location and the one or more metal hydroxides are accumulated in a second location different from the first location.

In some embodiments of the apparatus or system, the one or more products comprising one or more dissolved metal ions have a concentration of at least 1 ppm (e.g., at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, or 500 ppm) in the first chamber.

In some embodiments, the one or more products comprising one or more dissolved metal ions have a concentration of less than 15 ppm (e.g., less than 15, 14, 13, 12, 11, 10, 9, 8, 7, 6, 5, 4, 3, 2, 1, 0.9, 0.8, 0.7, 0.6, 0.5, 0.4, 0.3, 0.2, or 0.1 ppm) in the second chamber. For example, in some embodiments, the one or more products comprising one or more dissolved metal ions have a concentration of 0 ppm in the second chamber. In some embodiments, the one or more products comprising one or more dissolved metal ions have a concentration of 0.01 to 15 ppm in the second chamber (e.g., 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 ppm), including any and all ranges and subranges therein.

In some embodiments, the one or more dissolved metal ions are primarily concentrated in the first chamber. In some embodiments, the one or more dissolved metal ions are present in a location different from the first chamber and at a lower concentration.

In an aspect, provided is a method of producing one or more metal hydroxide, oxide, and/or carbonate compounds comprising:
providing an apparatus comprising an anode, a cathode, a liquid electrolyte, and optionally a separator membrane between the anode and the cathode:
providing one or more precursor compounds comprising one or more metal-bearing siliceous materials wherein the one or more precursor compounds are substantially insoluble in the liquid electrolyte and located in a first location;
applying a voltage between the anode and the cathode;
dissolving at least part of the one or more precursor compounds to form one or more soluble metal ions diffused in at least part of the liquid electrolyte;
accumulating one or more metal hydroxide, oxide, and/or carbonate compounds substantially in a second location different from the first location, wherein the one or more metal hydroxide, oxide, and/or carbonate compounds are substantially insoluble in water or in the liquid electrolyte (or have a low solubility of less than 1 g/100 ml (e.g., less than 0.5 g/ml) in water or less than 1 g/100 ml (e.g., less than 0.5 g/ml) in the liquid electrolyte).

In some embodiments, the one or more metal hydroxide, oxide, and/or carbonate compounds are substantially insoluble in water or in the liquid electrolyte. For example, the one or more metal hydroxide, oxide, and/or carbonate compounds may have a low solubility of less than 1 g/100 ml (i.e., 0.01 g/ml), including any and all ranges, subranges, and values therein. In some embodiments, the one or more metal hydroxide, oxide, and/or carbonate compounds may have a low solubility of less than 0.5 g/ml, including any and all ranges, subranges, and values therein, e.g., less than 0.5, 0.4, 0.3, 0.2, 0.1, 0.09, 0.08, 0.07, 0.06, 0.05, 0.04, 0.03, 0.02, or 0.01, etc., in the water or the liquid electrolyte.

In some embodiments of the method, the apparatus comprises:
a first chamber comprising the anode;
a second chamber comprising the cathode;
a conduit connecting the first chamber and the second chamber; and
optionally a separator (e.g., a membrane) placed in the conduit;
wherein the liquid electrolyte comprising a solvent (e.g., water) and optionally one or more additives;
wherein the one or more metal-bearing siliceous materials are positioned inside the first chamber and optionally close to the anode, wherein at least part of the one or more metal-bearing siliceous materials are dissolved in the solvent under the applied voltage for a time period by reacting with the H⁺ in the first chamber generated at or close to the anode; and wherein the one or more metal hydroxides, oxides, and/or carbonates, are accumulated substantially on the lower half of the conduit and/or on the lower half of the second chamber by reacting the soluble metal ion(s) with the OH⁻ diffused to the conduit from the second chamber wherein the OH⁻ is generated at or close to the cathode under the applied voltage by electrochemical reaction(s).

In some embodiments of the method, dissolving at least part of the one or more precursor compounds comprises one or more reactions of M1ₓ₁M2ₓ₂M3ₓ₃SiO_{y}+n1 H+→a1 M1^{b1+}+a2 M2^{b2+}+a3 M3^{b3+}+n2 SiO₂+n3 H₂O, wherein 0≤x1≤4, 0≤x2≤4, 0≤x3≤4, 1≤y≤8, x1+x2+x3>0, a1+a2+a3>0, b1≥1, b2≥1, b3≥1, n1>0, n2>0, and n3>0.

In some embodiments of the method, dissolving at least part of the one or more precursor compounds comprises one or more reactions of M1ₓ₁M2ₓ₂M3ₓ₃Oy+n1 H+→a1 M1^{b1+}+a2 M2^{b2+}+a3 M3^{b3+}+n2 O₂+n3 H₂O, wherein 0≤x1≤4, 0≤x2≤4, 0≤x3≤4, 1≤y≤8, x1+x2+x3>0, a1+a2+a3>0, b1≥1, b2≥1, b3≥1, n1>0, n2>0, and n3>0.

In some embodiments of the method, dissolving at least part of the one or more precursor compounds comprises one or more reactions of M1ₓ₁M2ₓ₂M3ₓ₃Alₓ₄Siₓ₅Oy+n1 H+→a1 M1^{b1+}+a2 M2^{b2+}+a3 M3^{b3+}+n2 SiO₂+n4 Al₂O₃+n3 H₂O, wherein 0≤x1≤4, 0≤x2≤4, 0≤x3≤4, 0≤x4≤4, 0≤x5≤4, 1≤y≤8, x1+x2+x3>0, a1+a2+a3>0, b1≥1, b2≥1, b3≥1, n1>0, n2>0, n3>0, and n4>0.

In some embodiments of the method, dissolving at least part of the one or more precursor compounds comprises one or more reactions of M1ₓ₁M2ₓ₂M3ₓ₃(OH)_{y}+n1 H+→a1 M1^{b1+}+a2 M2^{b2+}+a3 M3^{b3+}+n2 (OH)_{y}+n3 H₂O, wherein 0≤x1≤4, 0≤x2≤4, 0≤x3≤4, 1≤y≤8, x1+x2+x3>0, a1+a2+a3>0, b1≥1, b2≥1, b3≥1, n1>0, n2>0, and n3>0.

In some embodiments of the method, each of the M1, M2, and M3 is selected from group IA, IIA, IIIA, IVA, IB, IIB, IIIB, IVB, VB, VIB, VIIB, or VIIIB elements of the periodic table.

In some embodiments of the method, the metal(s) (e.g., M1, M2, or M3) are each independently selected from Ca, Mg, Al, Fe, Mn, Pb, Ni, Co, Zn, Cu, Mo, Pt, Pd, Rh, Ru, Ir, Os, La, Ce, Pr, Nd, Pm, Sm, Eu, Gd, Tb, Dy, Ho, Er, Tm, Yb, Lu, Sc, and Y.

In some embodiments of the method, at least 1% by weight (e.g., at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, or 32%) of the one or more metal-bearing siliceous materials are dissolved under a predetermined period (e.g., 24 hours or n hours wherein n is any number from 1 to 100 (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 hours, including any and all ranges and subranges therein)) under the applied voltage of at least 1.5 V (e.g., at least 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30 V, etc.).

In some embodiments of the method, the apparatus is configured to produce one or more metal hydroxide compounds under ambient temperature and/or ambient pressure (e.g., atmospheric pressure). In some embodiments of the method, the apparatus is configured to produce one or more metal hydroxide compounds, optionally one or more metal oxide compounds, under ambient temperature and/or ambient pressure.

In some embodiments of the method, the one or more precursor compounds comprise steel slag, minerals, mine-tailings, industrial residues, rocks, fly ash, ores, or brine with dissolved solids.

In some embodiments of the method, the one or more metal-bearing siliceous materials are selected from wollastonite, enstatite, olivine, basalt, serpentine, pyroxene, diopside, feldspar, mica, talc, sulfide ores, or gypsum, or is composed of or derived from rocks or ores containing one or more metal silicate(s).

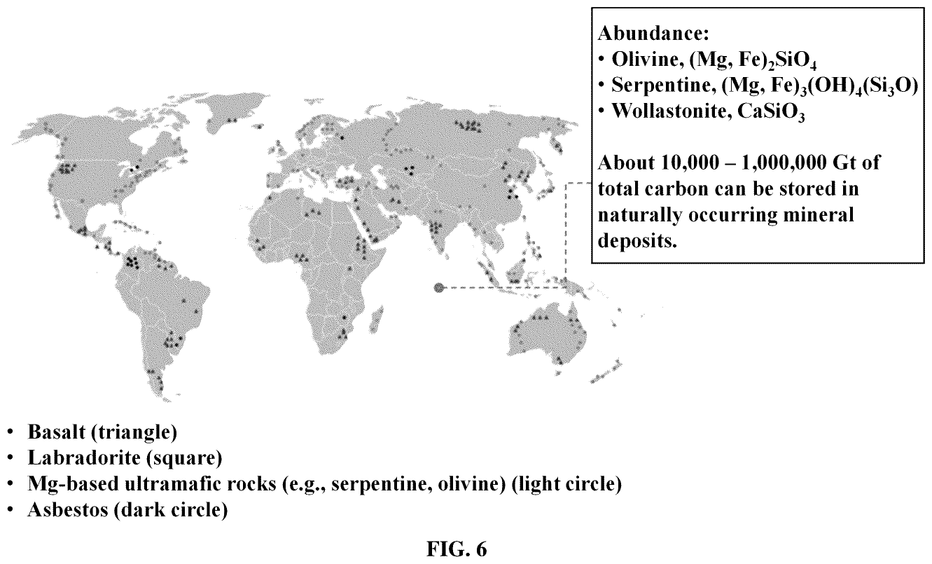

Now referring to FIG. 6, naturally occurring minerals around the world allow for about 10,000 to about 1,000,000 Gt of total storage capacity for carbon.

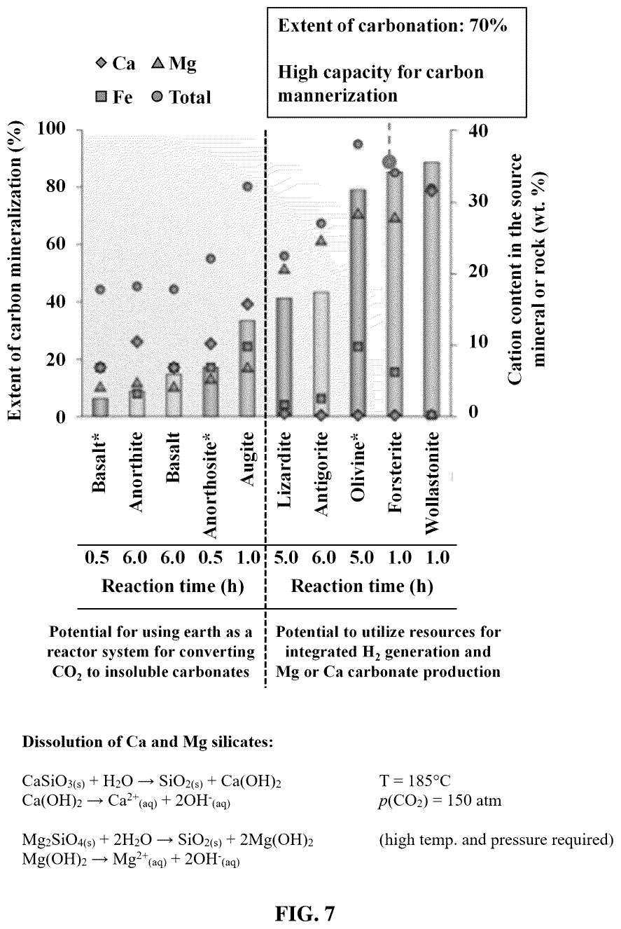

Now referring to FIG. 7, some naturally occurring minerals have the potential to use the earth as a reactor system to convert CO₂ to insoluble carbonate and others have the potential to be utilized for integrated H₂ generation and Mg or Ca carbonate production. FIG. 7 also depicts the dissolution of Ca and Mg silicates at required high temperature and pressure.

In some embodiments of the method, the apparatus or system is any apparatus or system as described herein.

In some embodiments of the method, the anode is at least partially submerged in the electrolyte and configured to generate acid (e.g., H⁺ ions). In some embodiments of the method, the cathode is at least partially submerged in the electrolyte and configured to generate hydroxyl ions (e.g., OH⁻ ions).

In some embodiments, the method further comprises collecting the accumulated one or more metal hydroxides, oxides, and/or carbonates. Generally, if there is any inorganic dissolved carbon present, carbonates will accumulate.

In some embodiments of the method, the conduit has a pH gradience from a first pH value to a second pH value, wherein the second pH value is greater than the first pH value. In some embodiments, the first pH value is acidic and the second pH value is basic. In some embodiments of the method, the conduit has a pH gradience (or non-uniform pH) from acidic to basic, or has a pH gradience from a first pH value of 0 (or less than 1 (e.g., less than 0, or 0, 0.1, 0.2, 0.3, 0.4, 0.5, 0.6, 0.7, 0.8, or 0.9, including any and all ranges and subranges therein)) at a first end of the conduit to a second pH value of 12, 13, or 14 (or greater than 10 (e.g., 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, or 14.0, including any and all ranges and subranges therein)) at a second end of the conduit.

In some embodiments, the method further comprises:
producing/collecting carbon dioxide (e.g., on top/in the upper half of the first chamber as a gas mixture comprising oxygen and carbon dioxide).

In some embodiments, the method further comprises:
introducing a gas stream comprising carbon dioxide;
absorbing at least part of the carbon dioxide by reacting the carbon dioxide with the one or more metal hydroxides or oxides to form one or more metal carbonates.

In some embodiments of the method, the first location and the second location are separated by at least one filter or membrane or at least one porous material.

In some embodiments of the method, the filter or membrane is one or more layer of a porous or fibrous material configured to prevent solid particles from passing from one side to another side.

Embodiments of the inventive apparatus, system, and method are distinguished from the disclosures within, e.g., US 2012/0183462 A1, which is hereby incorporated herein by reference.

### Synthesis of Functionalized Materials

Following are examples of functionalized silica that may be used for the recovery of select metals from a metal-containing solution.

TABLE 1
Functionalized silica (FS) and ligands with corresponding chemicals

| Functionalized silica | Ligands with corresponding chemicals |
|---|---|
| Si-M | —SH: (3-mercaptopropyl)trimethoxysilane (MPTMS) |
| Si-M-PolyIL | Polymerized ionic liquid: diphenyl(4-vinylbenzyl)(4- |
| | vinylphenyl)-phosphonium chloride |
| Si-M-VIL | Monomer ionic liquid: 4-vinylbenzyl(triphenyl)phosphonium |
| | chloride |
| Si-A3 | Tri-amino: 3-[2-(2-aminoethylamino)ethylamino]propyl- |
| | trimethoxysilane (AEPTS) |
| Si-AC | —COOH groups: Ethylchloroacetate (EC) |
| Fe-imprinted thiocyanato FS | —SCN groups: 3-Thiocyanatopropyltriethoxysilane |
| | (TCPTS) |
| Si-TBP | Tributyl phosphate (TBP) |
| Si-Cnx302 | Cyanex 302 (Cnx302) |
| Si-UPTS | 3-ureidopropyltriethoxysilane (UPTS) |
| Si-A₂-NB | Linker: 3-(2-aminoethylamino)propyltrimethoxysilane (A₂); |
| | Redox active ligand: Nile Blue |
| Si-AEPTS-ARS | Linker: 3-(aminopropyl)triethoxy silane (AEPTS); Redox |
| | active ligand: 3,4-Dihydroxy-9,10-dioxo-9,10- |
| | dihydroanthracene-2-sulfonic acid (Alizarin Red S) |
| Si-M-VF | Linker: 3-mercaptopropyl trimethoxysilane; Redox active |
| | ligand: vinyl-ferrocene |

### Synthesis of Si-M (e.g., —SH functionalized silica)

Pre-dried silica was prepared by drying activated silica gel in an oven at 400° C. for 16 h. In 150 ml toluene, 10 g pre-dried silica (with —OH termination groups) was mixed with 15 ml (3-marcaptopropyl) trimethoxysilane (MPTMS) and refluxed under N₂ atmosphere for 24 h. The product was cooled to room temperature, filtered by centrifugation, washed in MeOH, and dried in a vacuum oven for 24 h (Zaitseva, 2023).

The structure of Si-Mis:

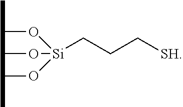

In some embodiments, Si-M may be used for the selective recovery of copper (Cu).

### Synthesis of Si-M-PolyIL (e.g., Polymerized Ionic Liquid Functionalized Silica)

Step 1: Synthesis of the monomer ionic liquid, i.e., diphenyl(4-vinylbenzyl)(4-vinylphenyl)-phosphonium chloride.

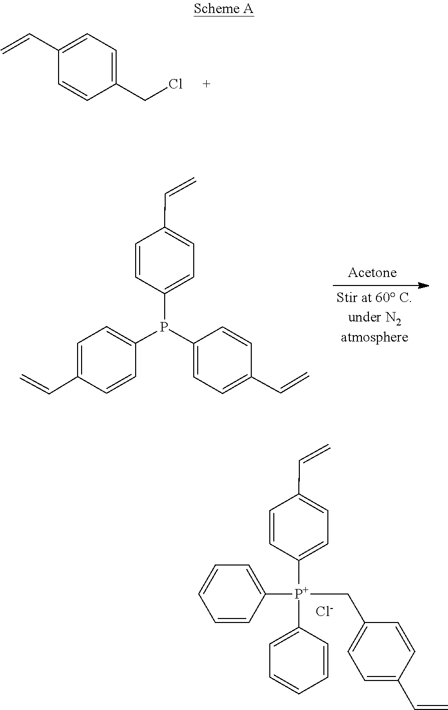

In 10 ml of acetone, 0.93 g 4-vinylbenzyl chloride was mixed with 1.48 g tris-(4-vinylphenyl)-phosphine. The mixture was stirred under N₂ atmosphere at 60° C. for 48 h (Sun et al., 2015).

Step 2: Tethering of the monomer ionic liquid onto the silica surface and polymerization.

In 30 ml dry EtOH, 5 g Si-M was mixed with 0.5 g diphenyl(4-vinylbenzyl)(4-vinylphenyl)-phosphonium chloride, and 0.058 g 2,2′-azobis(2-methylpropionitrile) was added and the mixture was stirred at room temperature for 2 h. The EtOH was evaporated by vacuum at 40° C. to yield a solid product that was dried in a vacuum oven. To the dried solid product was added 50 ml degassed EtOH under N₂ atmosphere and stirred at 78° C. for 20 h. The solvent was evaporated at 40° C. and the solid product purified with MeOH using Soxhlet extraction. The solid product was dried in a vacuum oven (Lanaridi et al., 2021). The loading of ligands was about 6% according to the thermal stability test using thermogravimetric analysis (TGA).

The structure of Si-M-PolyIL is:

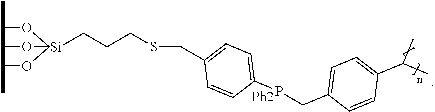

In some embodiments, Si-M-PolyIL may be used for the selective recovery of Pt, Pd, and/or Mn.

### Synthesis of Si-M-VIL (e.g., Monomer Ionic Liquid Functionalized Silica)

### Scheme B

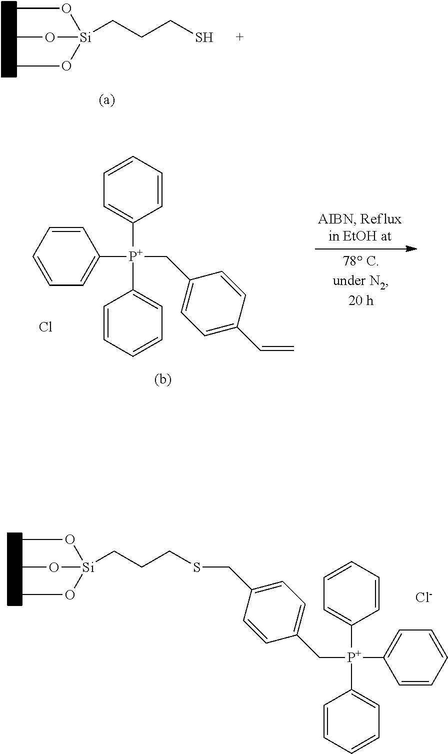

In 30 ml dry EtOH, 5 g Si-M was mixed with 0.5 g 4-vinylbenzyl(triphenyl)phosphonium chloride, 0.032 g 2,2′-azobis(2-methylpropionitrile) was added, and the mixture was stirred at room temperature for 2 h. The solvents, e.g., EtOH, were evaporated by vacuum at 40° C. to yield a solid product that was dried in a vacuum oven. To the dried solid product was added 50 ml degassed EtOH under N₂ atmosphere and stirred at 78° C. for 20 h. The solvent was evaporated at 40° C. and the solid product purified with MeOH using Soxhlet extraction. The solid product was dried in a vacuum oven. The loading of ligands was about 4.5% according to the thermal stability test using TGA.

The structure of Si-M-VIL is:

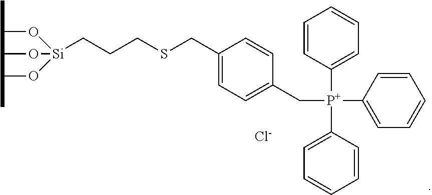 [SMILES: C[C@@H]1O[Si]2(CCCSCc3ccc(C[P+](c4ccccc4)(c4ccccc4)c4ccccc4)cc3)O[C@@H]1[C@@H](C)O2 ; [Cl-]]

In some embodiments, Si-M-VIL may be used for the selective recovery of Pt at pH <1. In some embodiments, Si-M-VIL may be used for the selective recovery of Co at about pH 3 to about pH 5.

### Synthesis of Si-A3 (e.g., AEPTS Functionalized Silica)

In 45 ml toluene, 14.5 g pre-dried silica was mixed with 14.5 ml 3-[2-(2-aminoethylamino)ethylamino]propyl-trimethoxysilane (AEPTS) and refluxed with stirring at 70° C. for 8 h (Qu et al. 2006).

The structure of Si-A3 is:

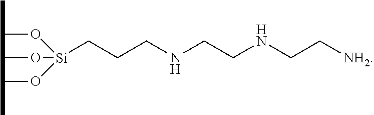 [SMILES: C[C@@H]1O[Si]2(CCCNCCNCCN)O[C@@H]1[C@@H](C)O2]

In some embodiments, Si-A3 may be used for the selective recovery of Mn.

### Synthesis of Si-AC (e.g., Grafting-COOH Ligands onto the Si-A3 Surface)

In 70 ml EtOH, 4 g Si-A3 was mixed with 50 ml ethylchloroacetate (EC). The suspension was stirred and refluxed at 80° C. for 48 h. The solid product was filtered and washed with EtOH three times. The solid powder was dried in a vacuum oven at 60° C. for 48 h. The —COO was hydrolyzed in 2 M HCl at 90° C. for 8 h (El-Nahhal et al., 2018).

The structure of Si-AC is:

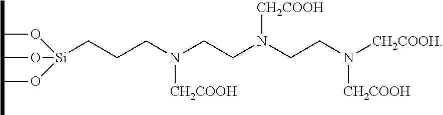

In some embodiments, Si-AC may be used for the selective recovery of Ni.

### Synthesis of Fe-Imprinted Thiocyanato FS (e.g., —SCN Functionalized Silica)

In a 500 ml flask, 6 ml 3-thiocyanatopropyltriethoxysilane (TCPTS) was mixed with 4.55 g FeCl₃·6H₂O in 200 ml methanol and stirred with heating for 2 h. Then, 2 g pre-dried silica gel was added with stirring at 30° C. for 24 h. Then, 8 ml epichlorohydrin was added with stirring at 30° C. for 2 h. The products were recovered by filtrating using a centrifuge and washed with ethanol. The washed product was mixed with 50 ml 6 M HCl and stirred for 2 h. The products were recovered by filtration and washed with DI water five times and then dried under vacuum at 30° C. for 24 h (Fan and Sun, 2012).

The structure of Fe-imprinted thiocyanato FS is:

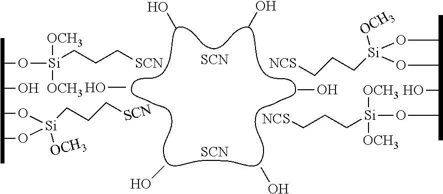

In some embodiments, Fe-imprinted thiocyanato FS may be used for the selective recovery of Fe.

### Synthesis of Si-TBP (i.e., Tributyl Phosphate Functionalized Silica)

TBP ligands are tethered onto silica surface by using sol-gel method where TBP, TEOS, and ethanol are mixed at room temperature. Next, 0.01 M HCl and water are added while stirring. Then, 1 M ammonia solution is added, followed by drying.

The structure of Si-TBP is:

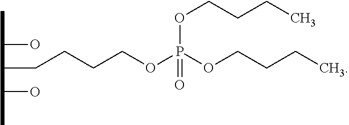 [SMILES: CCCCOP(=O)(OCCCC)OCCCC[C@@H]([C@H](C)O)[C@@H](C)O]

In some embodiments, Si-TBP may be used for the selective recovery of Fe.

### Synthesis of Si-Cnx302 (i.e., Cyanex 302 Functionalized Silica)

Cyanex 302 is tethered to silica surface.

The structure of Si-Cnx302 is:

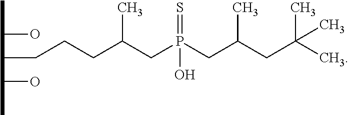 [SMILES: CC(CCC[C@@H]([C@H](C)O)[C@@H](C)O)CP(O)(=S)CC(C)CC(C)(C)C]

In some embodiments, Si-Cnx302 may be used for the selective recovery of Co at about pH 2. In some embodiments, Si-Cnx302 may be used for the selective recovery of Ni at about pH 8.

### Synthesis of Si-UPTS (i.e., UPTS Functionalized Silica)

3-ureidopropyltriethoxysilane (UPTS) is tethered to silica surface.

The structure of Si-UPTS is:

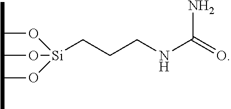 [SMILES: C[C@@H]1O[Si]2(CCCNC(N)=O)O[C@@H]1[C@@H](C)O2]

In some embodiments, Si-UPTS may be used for the selective recovery of Cr.

Efficiency of tethering of the ligands with functional groups was determined by FT-IR and Raman spectroscopy analyses.

### Synthesis of Si-A₂-NB

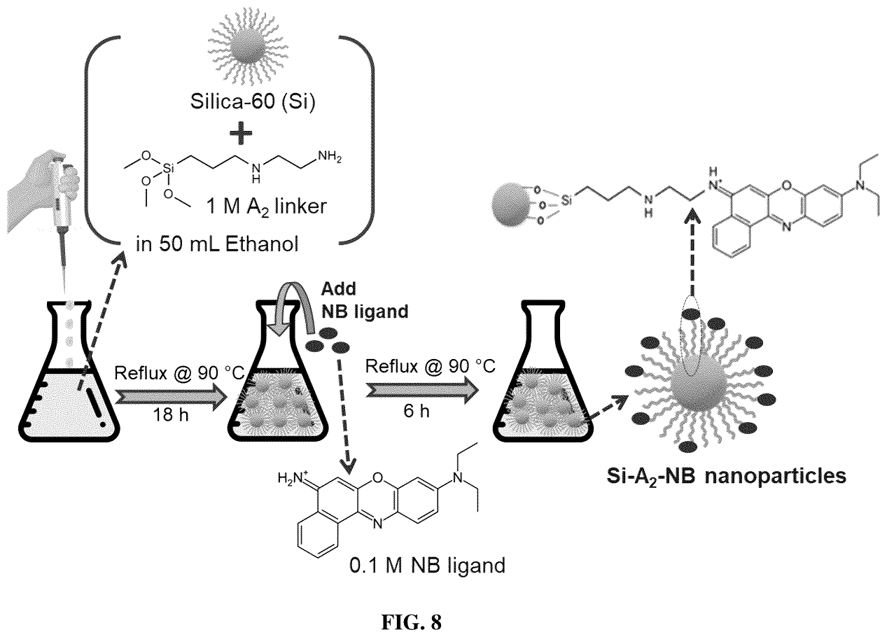

Mesoporous silica-60 (Si)-supported 3-(2-aminoethylamino) propyltrimethoxysilane (A₂) as linker with 1:1 mole ratio, was prepared by refluxing 5.0 g (ca. 50 mmol) Si with 9.0 mL (ca. 50 mmol) of A₂ in 50 mL of dry ethanol in a 250 mL round-bottom flask for 18 h at 90° C. Subsequently, 0.73 g (ca. 5 mmol) NB ligand was added to above mixture in proportion of 10:1 ratio refluxed at 90° C. for 6 h. The refluxed mixture was then cooled down to room temperature. The resulting purple solid was centrifuged with multiple rinsed with ethanol and then distilled water to wash away any untethered excess molecule. The product became purple solid when dried at 80° C. under vacuum for 24 h in vacuum oven. A schematic of the synthesis of Si-A₂-NB is shown in FIG. 8.

The Structure of Si-A₂-NB is:

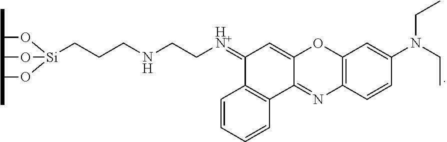

In some embodiments, Si-A₂-NB may be used for the selective recovery of zinc (Zn) from a metal-containing solution including zing and one or more other metals, e.g., Ni, Co, and/or Cu.

### Synthesis of Si-AEPTS-ARS (i.e., AEPTS-ARS Functionalized Silica)

Mesoporous silica-60 (Si)-supported 3-(aminopropyl)triethoxy silane (AEPTS) with 1:1 mole ratio, was prepared by refluxing 5.0 g (ca. 50 mmol) of Si with 10.0 mL (ca. 50 mmol) of AEPTS in 50 mL of dry ethanol for 6 h at 90° C. Subsequently, 0.99 g (ca. 50 mmol) of Alizarin Red S (ARS) (IUAC name: 3,4-Dihydroxy-9,10-dioxo-9,10-dihydroanthracene-2-sulfonic acid) ligand was added to the above mixture in proportion of 1:1 and refluxed at 90° C. for 18 h. The refluxed mixture was then cooled down to room temperature. The resulting purple solid was centrifuged with multiple rinsing cycles with ethanol and then distilled water to wash away any untethered excess molecule. The product became purple solid when dried at 80° C. under vacuum for 24 h in vacuum oven. A schematic of the synthesis of Si-AEPTS-ARS is shown in FIG. 9.

Materials. Among the chemicals employed in this work are mesoporous silica-60 (Si) (60 μm diameter), 3-(aminopropyl)triethoxy silane (AEPTS) as linker and redox active ligand such as 3,4-Dihydroxy-9,10-dioxo-9,10-dihydroanthracene-2-sulfonic acid) commercially trade name as Alizarin Red S (ARS) were procured from Merck-Sigma Aldrich, USA. Precious metals are used in nitrate and chloride form, silver (III) nitrate (AgNO₃), gold chloride (AuCl₂), palladium chloride (PdCl₂), platinum chloride (PtCl₂) were also acquired from Merck-Sigma Aldrich, USA. Organic reagent, ethyl alcohol (A grade) and striping agent hydrochloric acid (36% purity) were obtained from Thermoscintific, USA. The procured chemicals were used as such without any purification.

The structure of Si-AEPTS-ARS is:

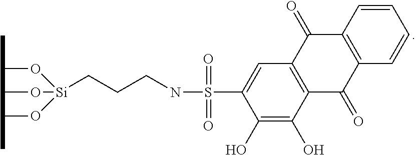 [SMILES: C[C@@H]1O[Si]2(CCCNS(=O)(=O)c3cc4c(c(O)c3O)C(=O)c3ccccc3C4=O)O[C@@H]1[C@@H](C)O2]

In some embodiments, Si-AEPTS-ARS may be used for the selective recovery of silver (Ag) from a metal-containing solution including Ag and one or more other metals. For example, the one or more other metals may be gold (Au), palladium (Pd), and/or platinum (Pt).

In some embodiments, Si-AEPTS-ARS may be used for the selective recovery of lanthanum (La) and/or cerium (Ce) from a metal-containing solution including La and/or Ce and one or more other metals. For example, the one or more other metals may be one or more transition metals.

### Synthesis of Si-M-VF (e.g., Vinyl-Ferrocene Functionalized Silica)

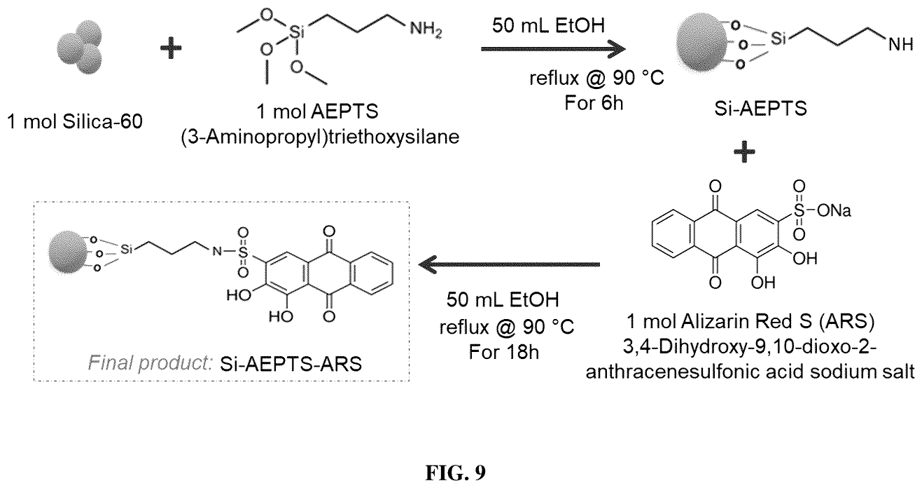

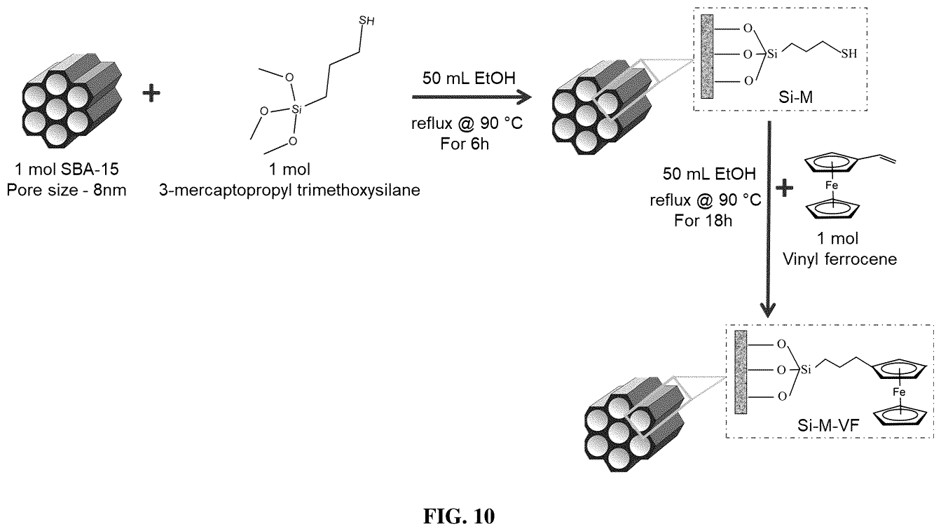

Mesoporous silica-SBA-15 (Si)-supported 3-mercaptopropyl trimethoxysilane (M) with 1:1 mole ratio, was prepared by refluxing 5.0 g (ca. 50 mmol) of Si with 10.0 mL (ca. 50 mmol) of M in 50 mL of dry ethanol for 6 h at 90° C. Subsequently, 0.53 g (ca. 50 mmol) of vinyl ferrocene (VF) ligand was added to the above mixture in proportion of 1:1 and refluxed at 90° C. for 18 h. The refluxed mixture was then cooled down to room temperature. The resulting yellow solid was centrifuged with multiple rinsing cycles with ethanol and then distilled water to wash away any untethered excess molecule. The product became yellow solid when dried at 80° C. under vacuum for 24 h in vacuum oven. A schematic of the synthesis of Si-M-VF is shown in FIG. 10.

Materials. Among the chemicals employed in this work are mesoporous silica SBA-15 (Si), 3-mercaptopropyl trimethoxysilane (M) as linker and redox active ligand such as vinyl ferrocene (VF) were procured from Merck-Sigma Aldrich, USA.

The structure of Si-M-VF is:

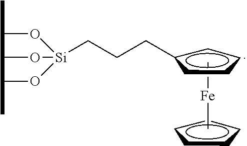

In some embodiments, Si-M-VF may be used for the selective recovery of nickel (Ni) from a metal-containing solution including Ni and one or more other metals. For example, the one or more other metals may include iron.

### Determination of Extraction Efficiency and Selectivity

The batch approach is adopted to extraction performance of the functionalized silica. The procedure to quantify the adsorption efficiency is as follows. 0.1 g functionalized silica was mixed with 5 ml metal-containing solution (10-40 ppm). The mixture was shaken and soaked for 5 hours at room temperature (RT), followed by filtration by centrifugation for 15 min to separate the extracted metal solution and spent silica. The concentration of the metal-containing solution before and after the extraction was determined using the Inductively Coupled Plasma Mass Spectrometry (ICP-MS) system.

Extraction efficiency of the inventive method (ne) can be evaluated using Eq. 1:

$${η}_{e} = \frac{{m}_{i , in} - {m}_{i , out}}{{m}_{i , in}} \times 1 \; 00 \% ; \qquad ( 1 )$$

where m_{i,in} and m_{i,out} represent the mass of the metal ion i before and after extraction, respectively.
Sorbent Regeneration and Metal Electroplating with Inherent Acid Regeneration

The sorbents were regenerated by desorbing the loaded metal ions from the spent functionalized silica using stripping agents. The stripping agents to desorb the metal ions from the spent functionalized silica are summarized in Table 2, with the stripping efficiency quantified using Eq. 2:

$${η}_{s} = \frac{{m}_{i , solid} - {m}_{i , stripping}}{{m}_{i , solid}} \times 1 \; 00 \% ; \qquad ( 2 )$$

where m_{i,solid} and m_{i,stripping} denote the mass of ion i retained on the silica particles and in the used stripping agent, respectively.

Generally, to regenerate the sorbent, 0.1 g spent functionalized silica was mixed with 20 ml stripping agents and shaken at RT for 5 hours.

TABLE 2
Summary of desorbing metal ions from
the spent functionalized silica

| | | Stripping | |
|---|---|---|---|
| Metal ions | Stripping agents | efficiency | References |
| Pd²⁺ | 1.0M thiourea | 100% | Lanaridi et al., 2020 |
| | in 1.0M HCl | | |
| Cu²⁺ | 37 wt. % HCl | 100% | Liu et al., 2000 |
| Fe³⁺ | 1-3M HCl | >90% | Sui et al., 2016 |
| Co²⁺ | 10% H₂SO₄ | 100% | Jha et al., 2013 |
| Ni²⁺ | 0.3M HCl | 100% | Singh et al., 2016 |
| Mn²⁺ | 0.5M HCl + | 100% | Ohshima et al., 1986 |
| | ascorbic acid | | |

The generation of hydroxyl ions resulting from water splitting are likely to produce hydroxide solids which may decompose into oxides (as in the case of iron (Yousefi et al. 2013)). Comprehensive characterization of the recovered solids may be conducted using XRD and high-resolution electron microscopy imaging (SEM/TEM) coupled to the quantification of metal composition.

### Metal Recovery Using Electrodeposition

Once the metal ions are desorbed from the spent functionalized silica, the desorbed metal ions in the stripped solution may be recovered via electrodeposition to obtain the metallic form, except for Fe³⁺ and Mg²⁺ ions. The concentration of specific metal ions, the applied electrolyte, pH, and experiment temperatures are summarized in Table 3.

TABLE 3
Summary of metal ions electrodeposition

| | | | Temp. | | |
|---|---|---|---|---|---|
| Metal | Electrolyte | pH | (° C.) | Deposited form | Reference |
| PdCl₂ | Sodium | Acid | 25-45 | Pd | J. A. Abys, H. K. Straschil, |
| | chloride | | | | U.S. Pat. 5,178,745 (12 |
| | | | | | Jan. 1993) |
| Pd(NO₃)₂ | Sulfuric acid | Acid | 20-35 | Pd | Atkinson and Raper 1932 |
| Pd(NO₃)₂ | Nitric acid | Acid | — | Pd | Liu et al. 2013 |
| CuSO₄ | Sodium | 2.56 | — | Cu | Alebrahim, Khattab, and |
| | chloride | | | | Sharif 2015 |
| CuSO₄ | Sulfuric acid | 1-3 | 25 | Cu | Grujicic and Pesic 2002 |
| Fe(NO₃)₂ | — | — | 8 | First Fe(OH)₃, | Yousefi et al. 2013 |
| | | | | later Fe₂O₃ | |
| CoSO₄ | Sodium | 3-4 | 60 | Co | Sharma et al. 2005 |
| | sulfate | | | | |
| CoSO₄ | Boric acid | Acid | — | Co | Cohen-Hyams, Kaplan, and |
| | Citric acid | Neutral | | | Yahalom 2002 |
| NiSO₄ | Ammonium | 7.7-9.4 | 90-95 | Ni | SKITAŁ et al. 2019 |
| | hydroxide | | | | |
| | Ammonium | | | | |
| | chloride | | | | |
| MnSO4 | Ammonium | 3 | — | Mn | Fernández-Barcia et al. |
| | sulfate | | | | 2018 |
| | Boric acid | | | | |
| Mg(NO₃)₂ | KNO₃ | — | RT | Mg(OH)₂ | Zou et al., 2007 |

For ferric ions (Fe³⁺), when the voltage is applied to the solution (for example, ferric nitrate solution), ferric hydroxide is firstly formed due to the increase of the local pH around the surface of the cathode, and later it is converted to form Fe₂O₃ (Yousefi et al. 2013).

For magnesium ions (Mg²⁺), magnesium hydroxide (instead of pure magnesium) is formed when electrochemical reaction is conducted to the magnesium nitrate solution due to the combination of Mg²⁺ with OH⁻ ions on the cathode (Zou et al., 2007). The formed Mg(OH)₂ could be further utilized in CO₂ capture, utilization and storage pathway.

Generally, to recover metals using electrodeposition, the pH was regulated by adding a corresponding acid or base to the required values listed in Table 3, then an appropriate electrolyte was added to enhance the conductivity of the solutions for electroplating. Next, a voltage was applied to the electrodes to achieve a desired current density. The cathode was removed, washed with DI water, and dried in an oven. The metals were then scraped off from the cathode surface.

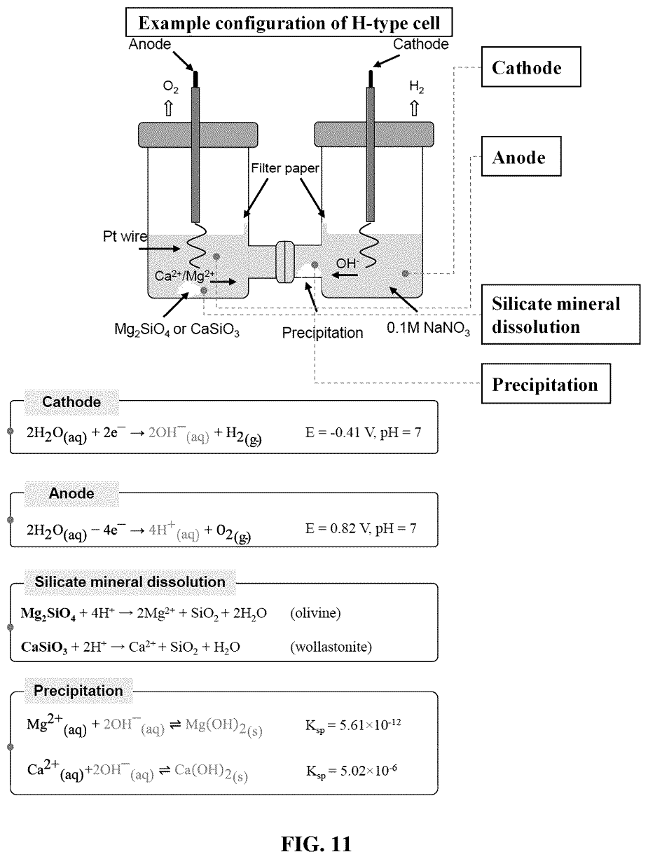

Now referring to FIG. 11, shown is a non-limiting example of a configuration of H-type cell and the reactions occurring throughout the system. Specifically, shown is the electrochemical dissolution of Ca- and Mg-bearing siliceous materials to co-produce Ca- and Mg-hydroxides, H₂, and O₂.

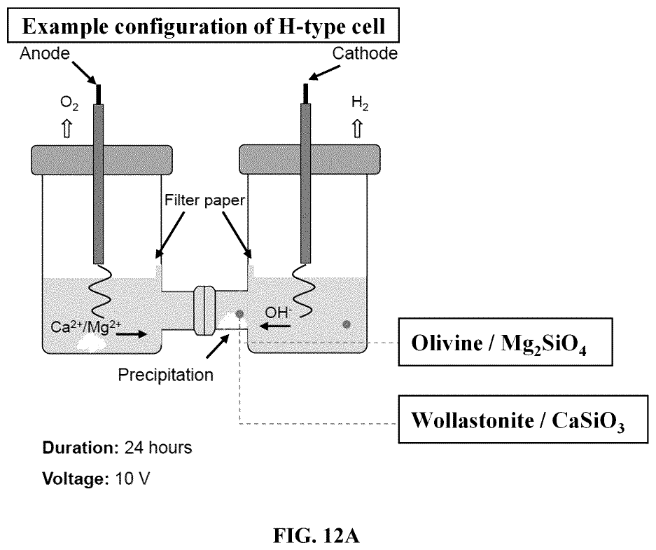

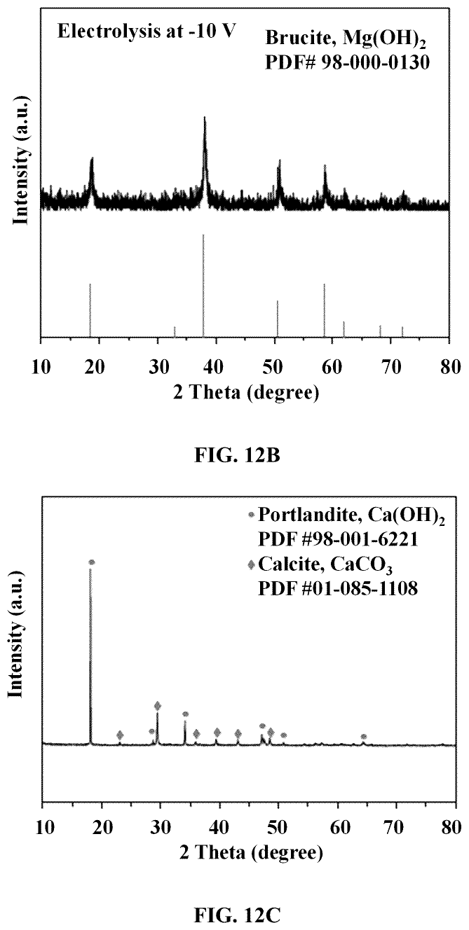

Now referring to FIGS. 12A-12C, shown are a non-limiting example of a configuration of H-type cell (FIG. 12A) and intensity graphs evidencing the electrochemically induced formation of Mg(OH)₂ and Ca(OH)₂+CaCO₃ (FIG. 12B and FIG. 12C).

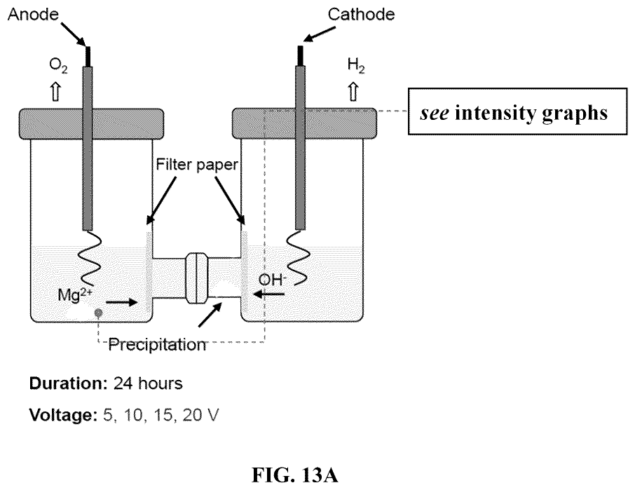

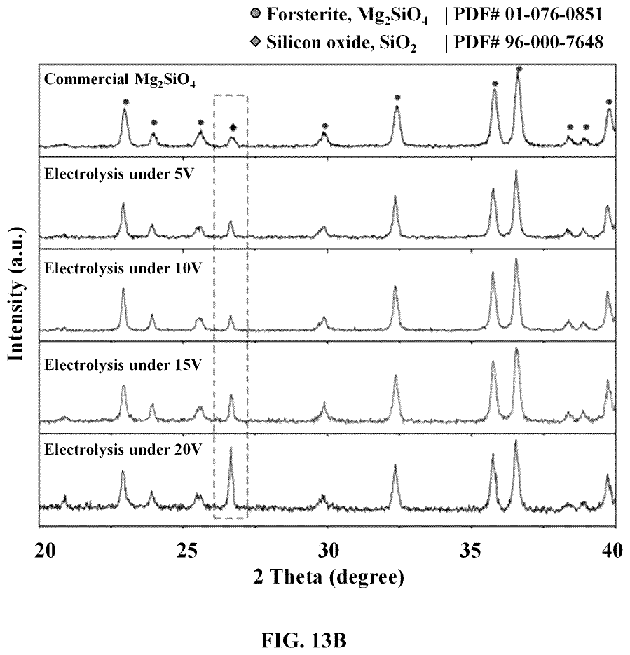

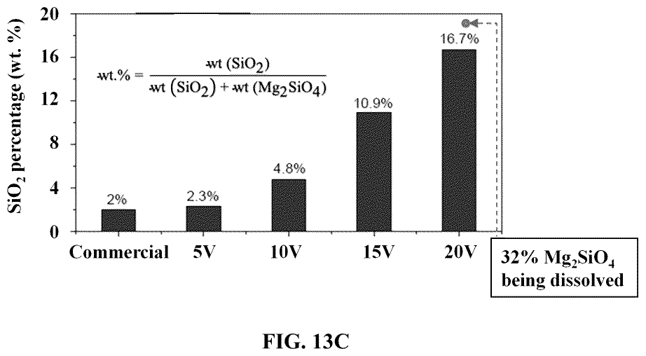

Now referring to FIGS. 13A-9C, shown are a non-limiting example of a configuration of H-type cell (FIG. 13A) and evidence of the electrochemical recovery of silica (FIG. 13B and FIG. 13C).

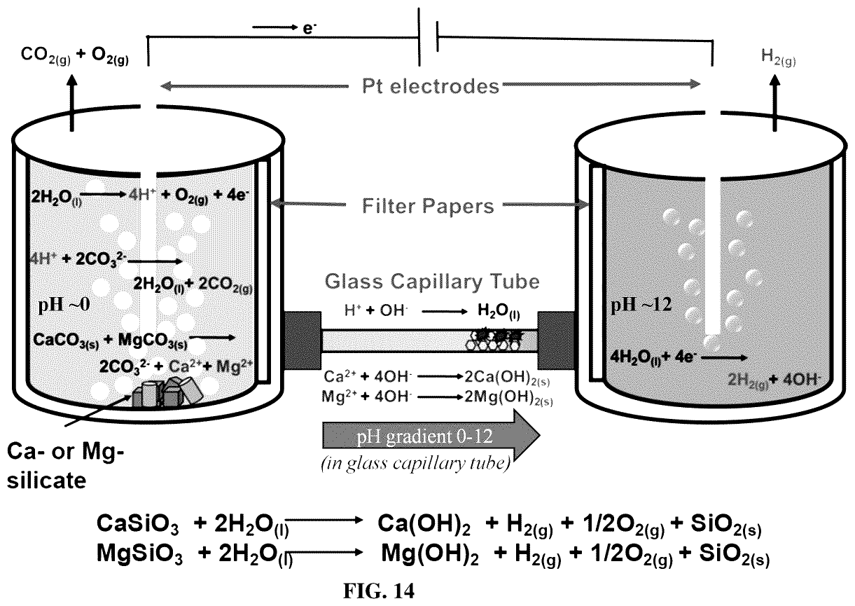

Now referring to FIG. 14, shown is a schematic of examples of possible electrochemical reactions that may occur during the process, e.g., electrochemical recovery of Ca- and Mg-hydroxides, silica, H₂, and O₂.

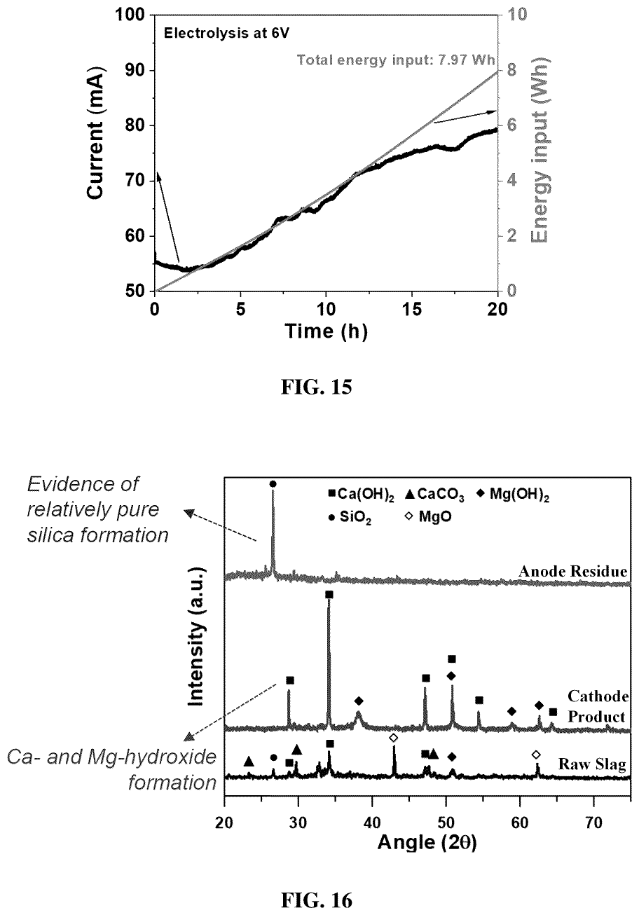

Now referring to FIG. 15, shown is a graph of the overall energy input for an example process.

Now referring to FIG. 16, shown is evidence of silica precipitation and Ca- and Mg-hydroxide formation based on x-ray diffraction (XRD) analysis.

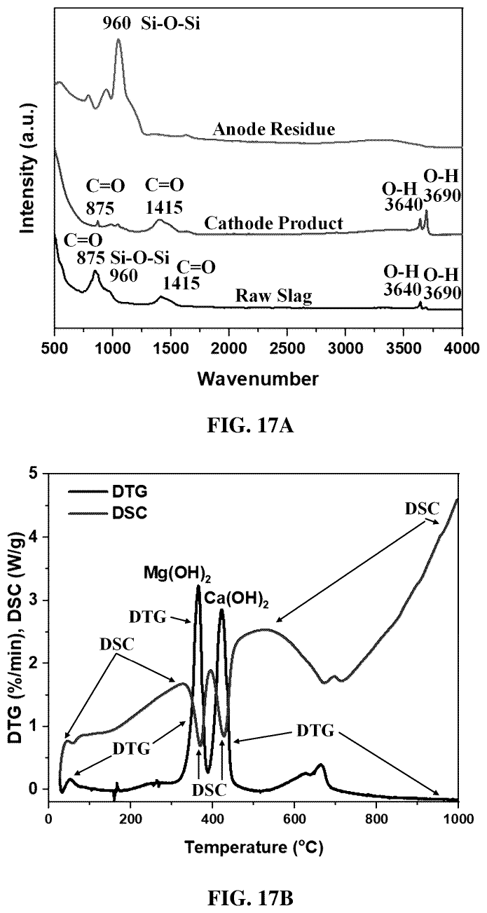

Now referring to FIG. 17A, shown is evidence of hydroxide formation based on Fourier transform infrared (FTIR) spectroscopy analysis.

Now referring to FIG. 17B, shown is evidence of hydroxide formation based on derivative thermogravimetry (DTG) analysis.

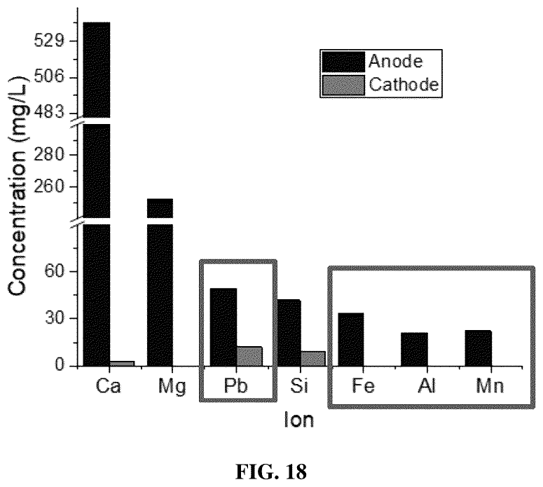

Now referring to FIG. 18, shown is a graph of the concentration of metals in the anode and cathode chambers. The concentration of metals is quantified in Table 4, below.

TABLE 4
Quantification of metals in the anode and cathode chambers.

| | Anode Chamber | Cathode Chamber |
|---|---|---|
| Metal | (ppm) | (ppm) |
| Al | 20.8 | 0 |
| Ca | 541.0 | 3.3 |
| Fe | 33.1 | 0 |
| Mg | 251.8 | 0 |
| Mn | 22.2 | 0 |
| Pb | 49.1 | 12.2 |
| Si | 51.8 | 9.0 |
| Zn | 7.8 | 0 |

### Batch Adsorption-Desorption

0.05 g adsorbent (e.g., functionalized material; in this example, Si-A₂-NB) was weighed and put into a 10 mL centrifuge tube, consequently 5 mL metal solution was added as a function of pH swing (adjusted with concentrated HNO₃) and concentration of metal ions, then it was mixed properly with vortex stirrer. Metal ions were reacted to adsorbent at room temperature as a function of time to understand the adsorption kinetics. After 180 min, the mixture was separated by sorbent extraction using centrifuge for separation. Supernatant were collected in separate centrifuge tubes and adsorbent was again washed with 5 mL distilled water to remove excess metal from the adsorbent. The concentration of metal ions in the solution was measured by ICP-OES after dilution with 5% HNO₃. The characteristic bond changes of the adsorbent before and after metal adsorption were analyzed by XPS (Thermo-Nexsa-G2-XPS-Surface analysis system, Cornell Center for Materials Research facilities, USA).

Desorption of the metal loaded adsorbent were performed with 0.05 M HCl as stripping solution. The adsorption capacity Q (mg/g), adsorption efficiency E (%), and desorption efficiency Ed (%) were obtained from Eq. 3 through 5, as follows:

$$Q = \frac{{C}_{0} - C}{m} x V ; \qquad ( 3 )$$

$$E = \frac{{C}_{0} - C}{{C}_{0}} \times 100 \% ; \qquad ( 4 )$$

$$Ed = \frac{{C}_{d}}{{C}_{0} - C} \times 100 \% ; \qquad ( 5 )$$

where, m (g) is the mass of the adsorbent and V (mL) is the volume of the liquid phase. C₀ and C (mg/L) are the ion concentrations in the liquid phase before and after adsorption, and C_{d} (mg/L) is the ion concentration in the liquid phase after desorption.

### Adsorption Isotherm

Adsorption isotherm is studied to know the adsorbent and adsorbate follows which mechanism. Here in this study two different isotherm models are used i.e., Langmuir and Freundlich. The concentration of a medium above a solid surface at a given temperature and the amount of molecules covering the solid surface are related by the Langmuir equation. It indicates that absorption happens on a homogenous surface via monolayer sorption without interaction between adsorbed molecules and is one theoretical approach. This model can be examined by Eq. 6, as follows:

$${q}_{e} = \frac{{q}_{m {K}_{L} {C}_{e}}}{1 + {K}_{L} {C}_{e}} ; \qquad ( 6 )$$

where, qₑ is the adsorption capacity, mmol g⁻¹, qₘ is represent the maximum adsorption capacity of adsorbent, mmol g⁻¹, K_{L} is the Langmuir constant that is related to the affinity of binding sites, L mmol⁻¹, Cₑ is the equilibrium concentration of metal ions, mmol g⁻¹.

The linear expression of the Langmuir isotherm is Eq. 7, as follows:

$$\frac{{c}_{e}}{{q}_{e}} = \frac{{c}_{e}}{{q}_{m}} + \frac{1}{{qK}_{L}} . \qquad ( 7 )$$

An empirical equation to examine interactions between adsorbed molecules and a heterogeneous energy distribution of active sites of adsorbent, the Freundlich isotherm is used as shown in Eq. 8, as follows:

$${q}_{e} = {K}_{F} {C}_{e}^{\frac{1}{n}} ; \qquad ( 8 )$$

where K_{F} is the binding energy constant reflecting the affinity of the adsorbents to metal ions (mmol^{1-(1/n)} L^{1/n} g⁻¹) and n is the Freundlich exponent related to adsorption intensity. The linear expression of the Freundlich isotherm is Eq. 9, as follows:

$$ln {q}_{e} = ln {K}_{F} + \frac{ln {C}_{e}}{n} . \qquad ( 9 )$$

### Adsorption Kinetics

Kinetics were measured with the 0.05 g adsorbent (e.g., functionalized material; in this example, Si-A₂-NB) mixed with 500 ppm of each metal in the metal-containing solution @pH 5 as a function of time followed by the same procedure explained as above. The equilibrium isotherm was measured at different time from 0 to 180 min. To evaluate the adsorption process of metal adsorbed on the adsorbent, pseudo-first-order (PFO) and pseudo-second-order (PSO) kinetic models were used to fit the experimental kinetic data.

The pseudo-first-order equation (Lagergren's equation) describes adsorption in solid-liquid systems based on the adsorption capacity of solids. The linear form of pseudo first-order-model can be expressed by Eq. 10, as follows:

$$log ( {q}_{e} - {q}_{t} ) = log {q}_{e} - \frac{{K}_{1} t}{2.303} ; \qquad ( 10 )$$

where, K₁ (min⁻¹) is the rate constant of the pseudo-first order adsorption. qₑ and qₜ (mg/g) are the adsorption capacities at equilibrium and at time t (min), respectively. The rate constants K₁, qₑ and correlation coefficients R² were calculated using the slope and intercept of plots of log (qₑ−qₜ) vs.t.

The pseudo-second-order rate expression, which has been applied for analyzing chemisorption kinetics from liquid solutions, is linearly expressed as Eq. 11, below:

$$\frac{t}{{q}_{t}} = \frac{1}{{K}_{2} {q}_{e}^{2}} + \frac{t}{{q}_{e}} ; \qquad ( 11 )$$

where, qₑ and qₜ are the adsorption capacity at equilibrium and time t (mg/g), K₂ (g mg⁻¹ min⁻¹) is the rate constant of the pseudo-second-order adsorption. The rate constants K₂, qₑ and correlation coefficients R² were calculated from the linear plots of t/qt vs. t.

### Regeneration

After treatment, the exhausted adsorbent was collected for regeneration. Initially the adsorbent was loaded by the metal ions by mixing around 0.05 g of adsorbent (e.g., functionalized material; in this example, Si-AEPTS-ARS) with 5 mL of 100 mg/L each metal (Ag, Au, Pd, Pt) in mixed solution. After attaining equilibrium, the spent adsorbent was separated from the solution using centrifuge. Metal ions were eluted by mixing the adsorbent with 5 mL of 0.05 M HCl. Treated effluents were collected and chemically analyzed for metal determination. The regeneration cycles were performed up to five times. The regeneration efficiency (% RE) of the adsorbent was calculated using Eq. (12):

$$\% RE = \frac{{q}_{r}}{{q}_{0}} \times 100 \% ; \qquad ( 12 )$$

where q₀ and qᵣ are the adsorption capacities of the adsorbents before and after regeneration respectively.

### Electrochemical Capture and Regeneration

Working electrode preparation. A modified silica paste electrode for the electrochemical sensor was fabricated by homogenization followed by mixing using agate pestle and mortar. The adsorbent (e.g., functionalized material; in this example, Si-A₂-NB), was mixed with mineral oil to form a fine paste. A Teflon tube served as the electrode body. The electrode body was filled with the fine paste, and electrical contact was established by placing a copper wire through the center of the electrode body/tube. To ensure properly packed paste inside the tube, electrode surface was scrubbed against a bond paper until the surface was smooth.

Electrochemical setup and analysis. For electrochemical performance, potentiostate (Gamry interface 1010E, USA) was used. Cyclic voltammetry was conducted to investigate the characteristic electrochemical properties of the redox active NB dye. Experiments were conducted with a three electrodes system setup where a modified silica paste was used as the working electrode, Ag/AgCl (saturated with 3 M KCl) was used as the reference electrode, and Platinum mesh was used as the counter electrode with 0.5 M NaCl (pH~5) as the supporting electrolyte at a scan rate of 10 mV/s.

Electrochemical uptake, release and regeneration. 1000 ppm metal mixtures at pH 5 were used with 0.5 M NaCl as electrolyte. The metal uptake at constant negative potential applied for 1 h as ligand was reduced at negative potential. After 1 h, metal adsorbed to the ligand was calculated by measuring the concentration of remaining metal ions in the solution by ICP-OES after dilution with 5% HNO₃. 0.5 M NaCl as electrolyte at pH 5 solution was used as stripping solution. Positive voltage was applied for 1 h due to oxidation of ligand occurs to release metal to the solution. After 1 h, metal desorbed from the ligand into solution was calculated by measuring the concentration of released metal ions in the solution by ICP-OES after dilution with 5% HNO₃. The electrode regeneration experiments were carried out with multiple cycles of electrochemical desorption, the working electrode was reduced to neutralize the positive charge and reuse the electrode for cation adsorption. Chronopotentiometry was used for electrode reduction steps, with an applied current of −0.025 mA. The electrodes could then be subsequently used for further adsorption/desorption cycles.

### Characterization of Si-A₂-NB

The samples were analyzed to observe the changes of functional groups of the synthesized adsorbent Si-A₂-NB by Attenuated total reflectance-Fourier transform infrared spectroscopy (FTIR-ATR, Nicolet™ iS50, Waltham, MA). The elemental analyses of the adsorbent were analyzed by X-ray photoelectron spectroscopy (XPS, Thermo-Nexsa-G2-XPS-Surface analysis system, Cornell Center for Materials Research facilities, USA). The fitting of XPS data was performed using CasaXPS software. The pore size distribution, pore volume, and surface area of the Si-A₂-NB were analyzed by N₂ adsorption-desorption automatic specific surface area analyzer (BET, autosorb, Aton Paar, USA). The mass loss of organic components in the adsorbent was obtained by simultaneous thermal analyzer (TA Instruments, USA). The surface and cross-sectional morphology of the adsorbent were clearly observed by field emission scanning electron microscopy (Zeiss-Gemini-500-FESEM, Cornell Center for Materials Research facilities, USA) and size of synthesized particle were measured by particle size analyzer (Aton Paar PSA 1190, USA).

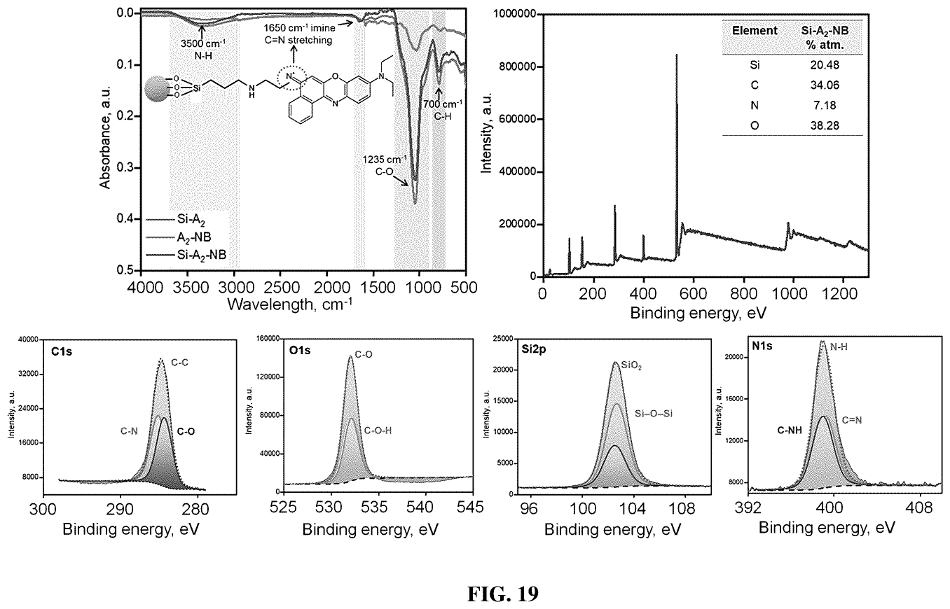

To determine the functional groups of mesoporous silica and modified silica (Si-A₂-NB), FT-IR characterization was carried out. The FT-IR spectra of the pristine mesoporous silica-60 and the modified Si-A₂ and Si-A₂-NB are shown in FIG. 19. There were several forms of silanol groups on the silica surface, including isolated, hydrogen-bonded, and germinal varieties. The asymmetrical stretching vibration of Si—O from the siloxane (Si—O—Si) group was responsible for the absorption peak at 1041 cm⁻¹. The absorption peak at wave number 800 cm⁻¹ indicated that the Si—O symmetry of Si—O—Si was present. The weak vibration bands bending vibrations of Si—O—Si groups at 413 cm⁻¹. The results of A₂ modified silica showed an absorption peak at 1550 cm⁻¹ indicating the presence of stretching vibration in primary amine from A₂. Tethering of NB onto Si-A₂ was achieved and the identification peak was noted as 1650 cm⁻¹ as imine (C═NH₂—R) formation. N—H stretching at 3500 cm⁻¹ was depicted due to presence of amine group in the NB ligand. Disappearance of primary amine group at 1550 cm⁻¹ in Si-A₂-NB demonstrated that NB was successfully tethered on Si-A₂ by elimination of NH₂ from A₂ and chemical bond formation between NB and A₂.

XPS spectroscopy provides detailed information based on binding energy of particular atoms and peak-fitting data was useful when a model was built from a collection of Gaussian or Lorentzian line shapes. FIG. 19 provides evidence that the chemical state of silicon was SiO₂. Tethering of NB on Si-A₂ was confirmed based on the binding energy changes and atomic percentage for Si, C, N and O, i.e., 20.48%, 34.06%, 7.18%, 38.28% respectively. The binding energy at about 285 eV is associated with C1s where the C—C bond shows a binding energy peak at 284.3 eV, C—N bond shows at 286.1 eV, and C—O bond shows at 283.5 eV. For O1S, the binding energy is associated at 532.9 eV, which is associated to Si—O and C—O peak. The binding energy at 103.50 eV correlates to Si—O peak position where it can be distributed into two peaks, one with SiO₂ and another with Si—O—Si. A peak change is observed in the case of N is associated with another element, where the binding energy peak position at 398 eV indicates that N is connected with other atoms like O and C. 397.8 eV is bind well with C—NH, 401.8 eV is bind well with C—N and 399.6 eV goes well with N—H. These changes in XPS peak position and distribution along with its associated binding energy indicated that NB and A₂ had been grafted on the surface of silica.

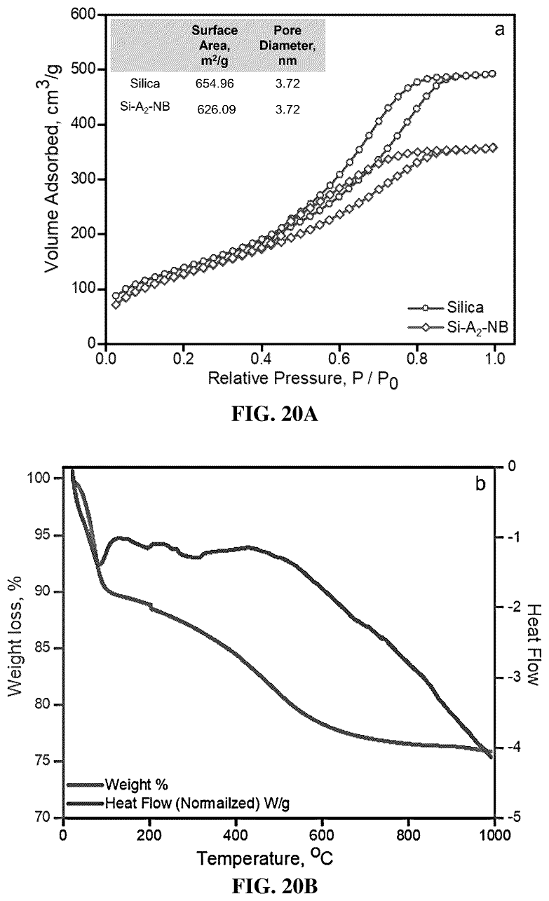

Consequently, the surface parameters, such as the specific surface area, pore volume and pore radius of the functionalized silica also changed significantly (FIG. 20A). The BET surface area of the modified silica had relatively the same pore size value as pristine and after ligand tethering i.e., about 3.72 nm which shows that there was no significant pore size modification by ligand. Si-A₂-NB has a lower exterior surface area, about 626.09 m²/g, than pure silica (about 654.96 m²/g), which may result in more surface contacts and tethering of redox active ligand, meaning that there is potential for a much higher ligand loading.

Thermogravimetric analyses of the functionalized silica were performed from 0° C. to 1000° C. to test the thermal stability of the functional material (FIG. 20B). A small weight loss (about 3 wt. %) occurred below 150° C. which is associated with the water physically adsorbed on surface. Between 250° C. and 600° C. the Si-A₂-NB had a large weight loss, indicating the decomposition of polybenzoxazine atoms from the ligand. A continuous and small weight loss was observed above 600° C., which can be attributed to the combustion of residual organic material or desorption of water resulting from silanol condensation. In this example, the total weight loss observed was about 24%.

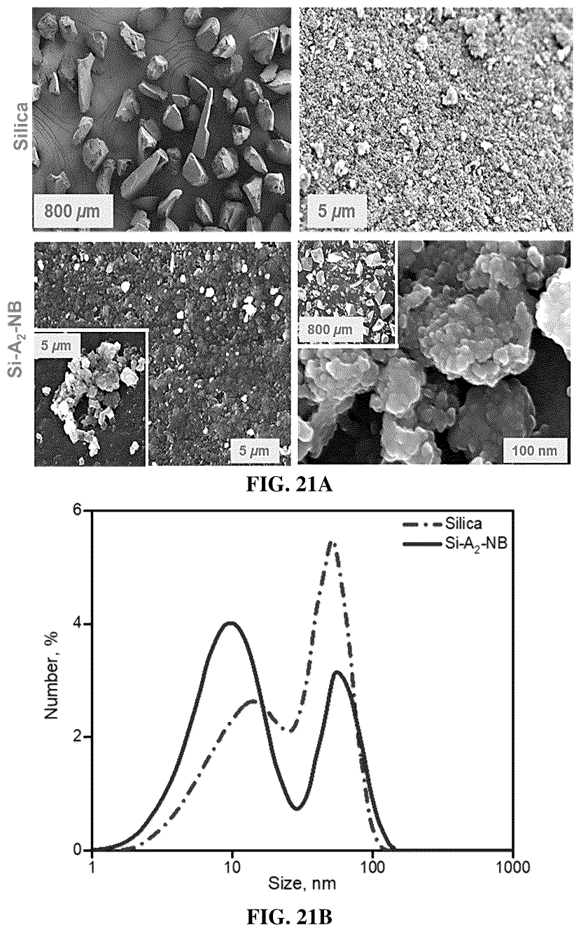

Morphological changes were observed by scanning microscopy of the functionalized silica. As seen in FIG. 21A, the functionalized silica showed the irregularly shaped particles. Since aggregation or agglomeration occurred in the interparticle condensation interaction during the drying process, small particles must agglomerate into bigger flocs. Consider the rough surfaces and smaller particle sizes as a factor increasing the surface area. The NB ligand was immobilized on the surface of the silica, which changed the silica's shape. The effective tethering of the ligand was further demonstrated by the micrometer-sized particle, which was further validated by measuring the size of the particle (FIG. 21B).

There was no significant correlation between the particle size and surface coverage of the adsorbent. In FIG. 21B, it was observed that the particle size of pristine silica was about 80 μm whereas size of Si-A₂-NB was about 3 μm and about 80 μm. The reduction in size was due to the condensation reaction and successful tethering of the ligand onto the silica, as evidenced by SEM morphology.

### Si-A₂-NB; Mode 1: Proton-Exchange Method/Adsorption-Desorption (pH Swing)

### Si-A₂-NB (Mode 1); Effect of Solution pH on Metal Adsorption

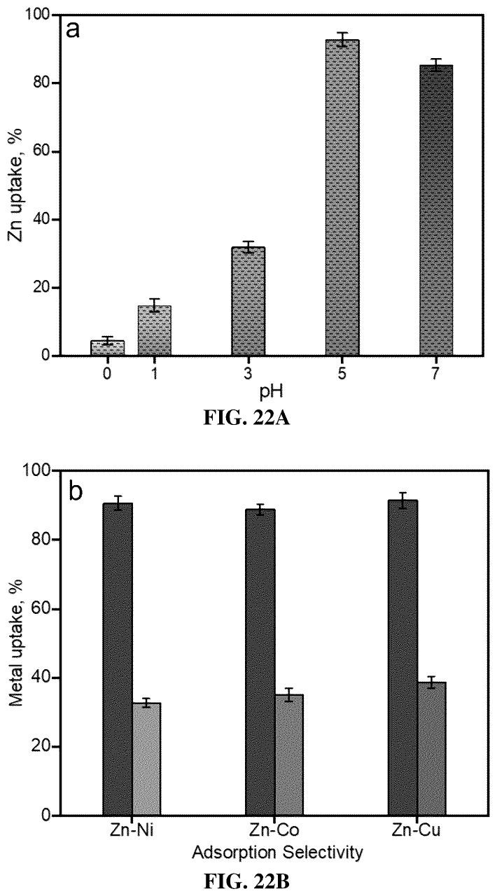

A solution pH influences the behavior in controlling the adsorption process by the ligand based conjugate nanomaterials during metals sorption. Activity of adsorbent surface charge and functional group may vary when the pH of the solution changes. Zinc, however, did not easily hydrolyze or form complexes; as a result, it existed in the solution as Zn throughout a wide pH range (from 0 to 7). The Zn uptake efficiency as a function of pH is shown in FIG. 22A. An increase in solution pH resulted in a considerable increase in Zn sorption. Near the surface of the Si-A₂-NB, a significant amount of hydronium ions (H₃O⁺) may provide a repulsive force that prevents the Zn ions from approaching. At a low pH range, the Zn sorption efficiency was noticeably poor because competing H ions made the obstacle with the Zn ions for the same adsorption sites. As shown in FIG. 22A, the Si-A₂-NB has the highest Zn sorption efficiency at pH 5 due to less H₃O⁺ ion competition. Because too many protons compete with zinc for the available active sorption sites in the proton exchange Si-A₂-NB adsorbent, zinc uptake was suppressed at acidic pH values. However, most of the surface sorption sites were deprotonated at high pH regions, which greatly increased the possibility of electrostatic interactions and allowed for extremely high efficiency zinc uptake. In many cases, it is plausible that the metals form coordinate covalent bonds with ligands where the metal donates a pair of electrons to the ligand, forming a shared pair of electrons between the metal and the ligand. Zn uptake as a function of pH was further validate by XPS peaks where it was seen that Zn does not get adsorbed up to pH 3 as there is no evidence for Zn peak at its associated binding energies. However, at 1020 eV and 1043 eV Zn peak with having Δ23 eV were observed from pH 5 onwards depicted that Zn is successfully adsorbed from pH 5. Accordingly, pH 5 was used to examine other experimental parameters.

Si-A₂-NB (Mode 1); Selectivity of metal uptake

Adsorption selectivity of metal uptake on Si-A₂-NB was examined by measuring the mixture of the target elements, i.e., 1000 ppm Zn—Ni, Zn—Co and Zn—Cu mixture, as shown in FIG. 22B; Zn (about 90%) uptake is very selective in respect to Ni (about 33%), Co (about 35%) and Cu (about 40%) metals. Furthermore, metal loaded ligands were tested by XPS analysis. Si-A2-NB can only selectively capture Zn from the solution as only the peak of Zn was present among the mixture of Zn—Ni, Zn—Co and Zn—Cu. Thus, Si-A₂-NB selectively captured Zn.

### Si-A₂-NB (Mode 1); Adsorption Isotherms

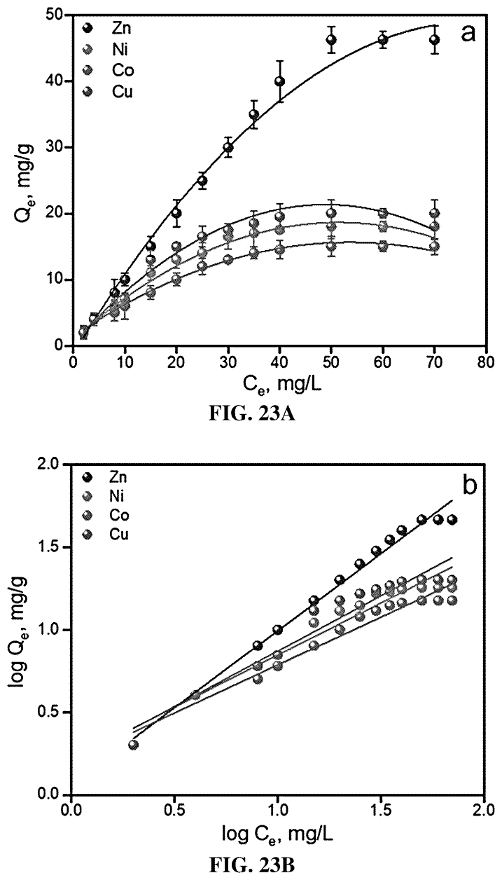

Adsorption isotherms may be used to explain adsorption data for a wide range of adsorbate concentrations. A comparison of two isotherms, Langmuir and Freundlich, was used to determine the adsorption isotherm parameters of Zn, Ni, Co, Cu onto Si-A₂-NB adsorbent (FIG. 23).

The Langmuir and Freundlich model parameters and fits of experimental data to the respective equations are shown in Table 5. The regression coefficients R² of the linear Langmuir models are more than 0.99, signifying that Langmuir isotherm model fitted well and can be used to define the Zn adsorption onto the Si-A₂-NB which directed that the adsorption come to pass at the functional groups and binding sites on the surface of the Si-A₂-NB through electrostatic bond or coordinate covalent bond formation could be possible with Zn and can be look upon as monolayer adsorption (Table 5; FIG. 23A).

From R² value (about 0.99) shown in Table 5, Freundlich isotherm can be used to describe the adsorption of Zn onto Si-A₂-NB (FIG. 23B). In addition, favorable adsorption tends to have a Freundlich constant n between 1 to 10. The n values in Table 5 are close to 1, depicting the chemical adsorption process is favorable and monolayer suggest that adsorption process obeys the Langmuir isotherm and Zn adsorbed via monolayer surface onto Si-A₂-NB.

The R² values for the Langmuir and Freundlich isotherms were the same and were the best fitting models for the experimental results. The data support that the adsorption process may be attributed to monolayer adsorption and chemisorption.

TABLE 5
Parameters of adsorption isotherm model for metal
adsorption on Si-A₂-NB via two different methods.

| | | | | |
|---|---|---|---|---|
| Model | Metal | Qₘ | K | R² |

Mode 1: Proton-exchange method (Adsorption-desorption)

| | | | | |
|---|---|---|---|---|
| Langmuir | Zn | 48.45 | K_{L} = 0.0166 | 0.9954 |
| | Ni | 17.78 | K_{L} = 0.0568 | 0.9942 |
| | Co | 15.01 | K_{L} = 0.0465 | 0.9933 |
| | Cu | 20.43 | K_{L} = 0.1138 | 0.9821 |
| Freundlich | Zn | n = 1.07 | K_{F} = 0.0588 | 0.9885 |
| | Ni | n = 1.58 | K_{F} = 0.2126 | 0.9488 |
| | Co | n = 1.72 | K_{F} = 0.2036 | 0.9624 |
| | Cu | n = 1.49 | K_{F} = 0.1984 | 0.9388 |

Mode 2: Electrochemical method (capture-release)

| | | | | |
|---|---|---|---|---|
| Langmuir | Zn | 49.9 | K_{L} = 0.0171 | 0.9942 |
| | Ni | 15.9 | K_{L} = 0.5717 | 0.9835 |
| | Co | 14.8 | K_{L} = 0.0472 | 0.9933 |
| | Cu | 17.4 | K_{L} = 0.1336 | 0.9821 |
| Freundlich | Zn | n = 1.05 | K_{F} = 0.0454 | 0.9918 |
| | Ni | n = 1.47 | K_{F} = 0.0978 | 0.9066 |
| | Co | n = 1.72 | K_{F} = 0.2036 | 0.9624 |
| | Cu | n = 1.49 | K_{F} = 0.1984 | 0.9388 |

### Si-A₂-NB (Mode 1); Influence of Contact Time and Adsorption Kinetics

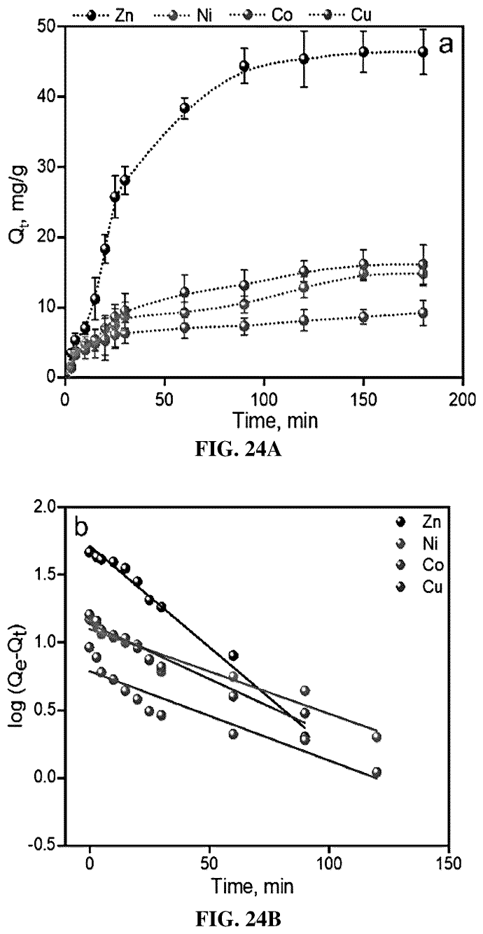

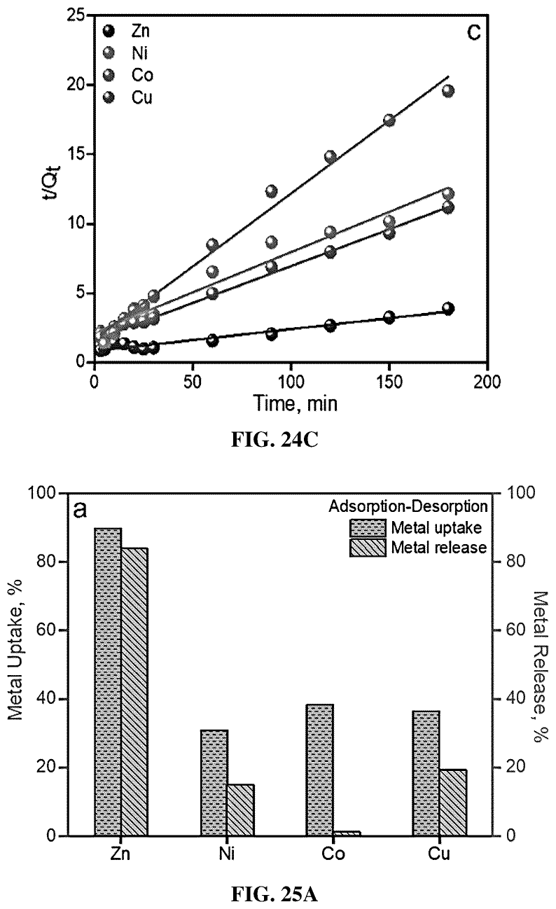

To measure the kinetics of metal adsorption over the Si-A₂-NB adsorbent via proton-exchange, the adsorption was monitored at different contact times from 0 to 180 min, as shown in FIG. 24A. The adsorption took place in two different steps. The amounts adsorbed of Zn by Si-A₂-NB increased rapidly during the first 20 min, and then gradually increased and finally reached equilibrium from 30 to 50 min.

To evaluate the adsorption process of Zn, pseudo-first-order (PFO) and pseudo-second-order (PSO) kinetic models were used to fit the experimental kinetic data, with fitted plots presented in FIGS. 24B and 24C. The parameters of the PFO and PSO models and the correlation coefficients (R²) estimated using the two models are given in Table 6. The fitness of the PFO adsorption indicates that the adsorption was strongly affected by the concentration of metal ions in solution and the significant chemical interaction within the adsorption mechanism. The value of Zn adsorption time was low in PFO fitted model (K₁ value from Table 6) and R² value is nearer to 1, i.e., about 0.9866 due to the very fast initial rate of adsorption compared PSO model exhibited. An increasing adsorption capacity (Qₑ) of about 46.4 mg/g compared to other metals because of Zn has the potential to lead to chemical interactions during adsorption. The adsorption rate of Zn is higher than other metals and fits in Lagergren's PFO adsorption kinetics rather than PSO adsorption kinetics, as indicated by the higher determination data of the PFO data simulation.

TABLE 6
Parameters of kinetic adsorption model for metal
adsorption on Si-A₂-NB via two different methods.

| | | | | |
|---|---|---|---|---|
| | | Q_{e,} | K₁, min⁻¹ | |
| Model | Metal | mg/g | K₂, gmg⁻¹ min⁻¹ | R² |

Mode 1: Proton-exchange method (Adsorption-desorption)

| | | | | |
|---|---|---|---|---|
| Pseudo-first- | Zn | 46.4 | K₁ = 0.0149 | 0.9866 |
| order | Ni | 14.8 | K₁ = 0.0062 | 0.9330 |
| | Co | 9.2 | K₁ = 0.0066 | 0.8682 |
| | Cu | 16.1 | K₁ = 0.0081 | 0.9533 |
| Pseudo- | Zn | 46.4 | K₂ = 0.0157 | 0.9500 |
| second-order | Ni | 14.8 | K₂ = 0.0579 | 0.9677 |
| | Co | 9.2 | K₂ = 0.1051 | 0.9924 |
| | Cu | 16.1 | K₂ = 0.0530 | 0.9930 |

Mode 2: Electrochemical method (capture-release)

| | | | | |
|---|---|---|---|---|
| Pseudo-first- | Zn | 49.4 | K₁ = 0.0229 | 0.8305 |
| order | Ni | 17.2 | K₁ = 0.0175 | 0.9185 |
| | Co | 8.8 | K₁ = 0.0145 | 0.9588 |
| | Cu | 11.6 | K₁ = 0.0382 | 0.6478 |
| Pseudo- | Zn | 49.4 | K₂ = 0.0059 | 0.3316 |
| second-order | Ni | 17.2 | K₂ = 0.0451 | 0.7957 |
| | Co | 8.8 | K₂ = 0.0732 | 0.8536 |
| | Cu | 11.6 | K₂ = 0.0106 | 0.1713 |

### Si-A₂-NB (Mode 1); Metal Uptake, Release and Regeneration Cycles

Through regeneration, the sorbent material can be reused multiple times, resulting in cost reduction. To ensure the effectiveness of adsorption, the adsorbate must be desorbed so the sorbent can be reused without significant deterioration in its original performance over several cycles.

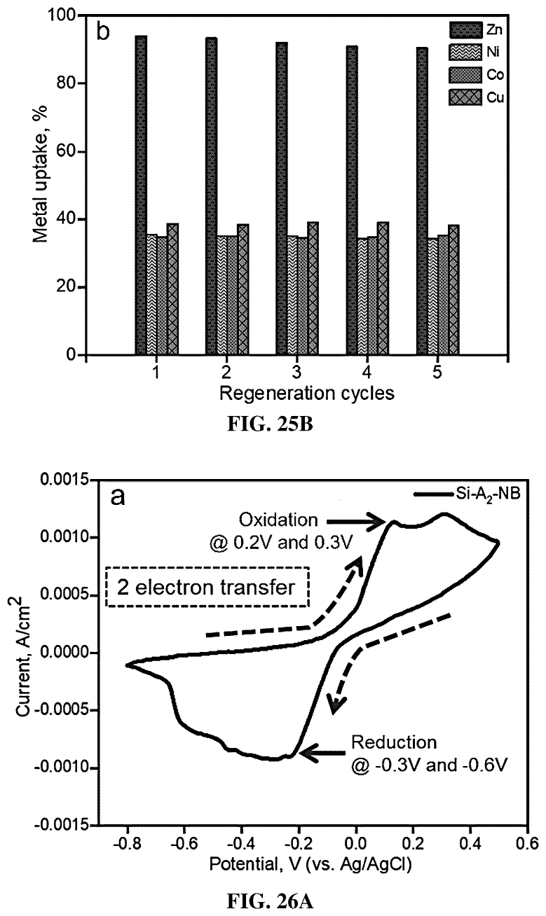

Sorption-elution-regeneration processes were conducted to investigate the possibility of chemically eluting and regenerating the sorbent material, Si-A₂-NB, for five cycles. The sorption efficiency of each cycle was compared with the initial sorption efficiency of Si-A₂-NB. As shown in FIGS. 25A and 25B, using a low concentration of HCl acid (0.05 M) effectively eluted the adsorbed Zn, allowing the adsorbent to retain its functionality. Approximately 94% of the Zn was successfully eluted from the adsorbent using an optimal concentration of 0.05 M HCl, indicating that an acidic condition facilitates the desorption of Zn from the exhausted adsorbents. The maximum capacity and exhaustion of adsorbent was measured with XPS and the maximum capacity of Zn uptake by Si-A₂-NB was determined.

During the regeneration process, Si-A₂-NB was simultaneously restored to its initial form after being washed with water for Zn capture. The adsorbent did not experience a significant loss in its adsorption capacities. Thus, Si-A₂-NB can be effectively reused for subsequent sorption operations, maintaining its performance.

### Si-A₂-NB; Mode 2: Electro-Adsorbed/Release Method (Electrochemical Swing)

### Si-A₂-NB (Mode 2); Redox Behavior

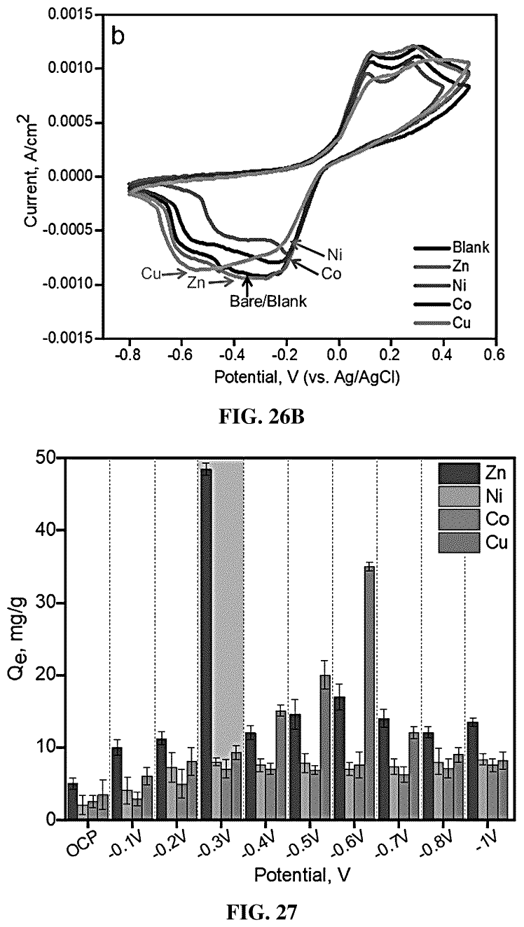

An electrochemical investigation of Si-A₂-NB and its redox capabilities was performed using cyclic voltammetry in 0.5 M NaCl electrolyte solution (FIGS. 26A and 26B). The results indicate that pristine Silica-60 does not show any redox behavior, while the introduction of the redox active dye NB to Silica-60 leads to interesting cyclic voltammograms (CV) with reversible redox peaks at −0.3 V and +0.2 V. To explore Si-A₂-NB's electrochemical characteristics further, 1000 ppm each metal solutions of Zn, Ni, Co, and Cu were studied using cyclic voltammetry. Zn demonstrated distinct electrochemical deposition and stripping behaviors between −1.0 V and +1.0 V vs Ag/AgCl, with deposition occurring at −0.3 V and stripping at +0.2 V. Both Ni and Co exhibited electrodeposition at −0.1 V and −0.15 V respectively, while electro-stripping took place at +0.1 V for both metals. As for Cu, deposition occurred at −0.6 V, and stripping at +0.2 V vs Ag/AgCl. Among the metals investigated, Zn displayed advantageous electrochemical properties, being efficiently adsorbed and desorbed within the operating voltage range of −0.3 and +0.2 V vs Ag/AgCl, without undergoing irreversible electrodeposition and stripping. Thus, Si-A₂-NB could be effectively utilized as a working electrode for Zn-related electrochemical processes within this potential range.

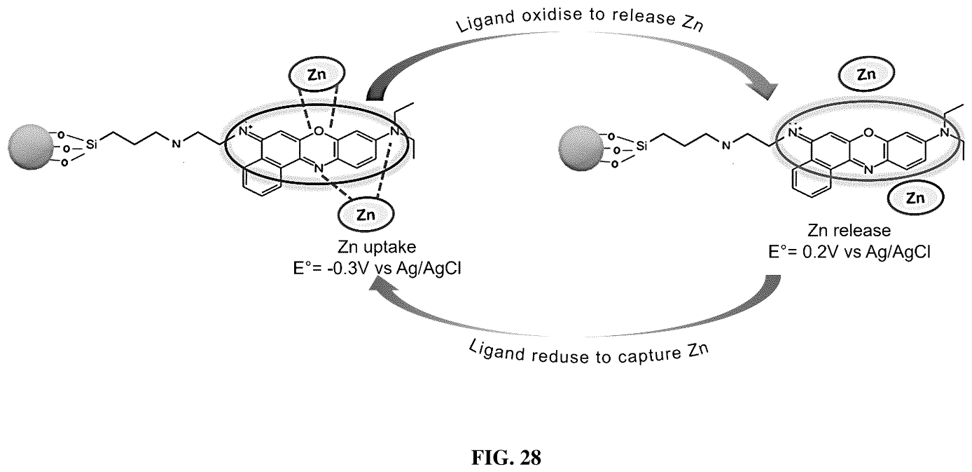

Adsorption experiments for metals were performed on several different potential scans to evaluate the effect of voltage and energy supply on metal capture. All experiments were performed under the same conditions (1000 ppm of aqueous solution containing Zn, Ni, Co, Cu each and 0.5 M NaCl, 1 h run time, open circuit, pH of 5, at room temperature). Based on experimental results as shown in FIG. 27, the Zn ion uptake increased with at −0.3V which is associated with reduction potential of NB. At −0.3 V, the redox active dye NB underwent a one-electron transfer reaction when it was modified on Silica-60. Generally during the redox process, one electron is released during the reduction (gain of electrons for metals) where metal is plausibly bonded through electrostatic interaction or coordinate covalent bond formation which is referred as metal uptake from solution towards the electrode and one electron is gained during the oxidation (release of electrons for metals) which referred as metal release from electrode to solution (FIG. 28). Negligible Zn uptake was observed on electrode with the different potential which shows redox active material was not able to reduce and metal could not bind provided little to no uptake by them.

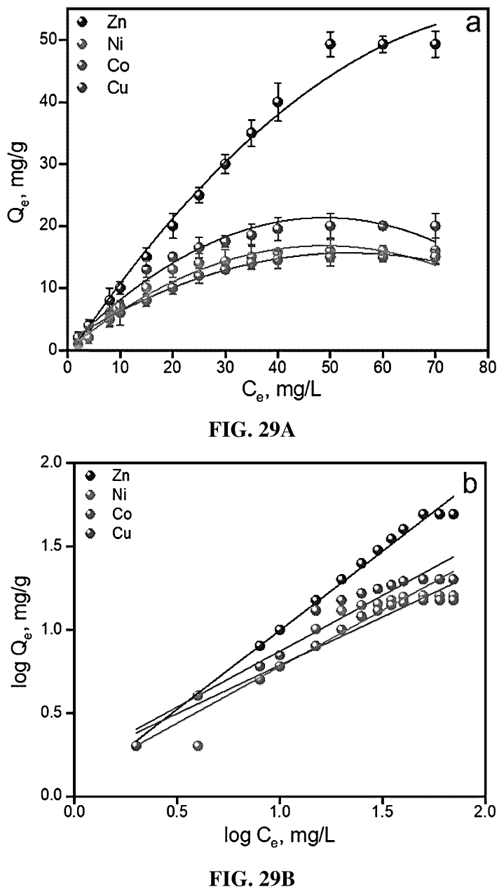

The electrosorption profiles at −0.3 V vs Ag/AgCl, shown in FIGS. 29A and 29B, were fitted to Langmuir and Freundlich adsorption models. The equilibrium data provided the parameters Qₘₐₓ and K_{L} for the Langmuir model, and n and K_{F} for the Freundlich model of adsorption was also estimated for the applied adsorption potential (Table 5). In the case of Zn adsorption, where the electrode was bound with redox-active adsorption sites, the Langmuir model provided a good fit to the electrosorption data with a high determination coefficient (R²=0.9942). This indicates that Zn electrosorption with the NB electrosorbent was well-captured by the Langmuir adsorption model. Furthermore, it was observed that the equilibrium Zn uptake reached approximately 49.9 mg/g at the applied potential (FIG. 29A). This suggests that the presence of a higher number of electrochemically generated adsorption sites facilitated faster ion transport of Zn to the electrode surface, leading to a higher uptake capacity.

Similar to proton exchange approach, electrosorption also obey the Freundlich isotherm as depicted from R² value (about 0.99) and n values close to 1 as shown in Table 5. These results depicting at certain applied potential, electrosorption can follow chemical adsorption process which favors monolayer adsorption to electrode surface.

### Si-A₂-NB (Mode 2); Influence of Contact Time and Adsorption Kinetics

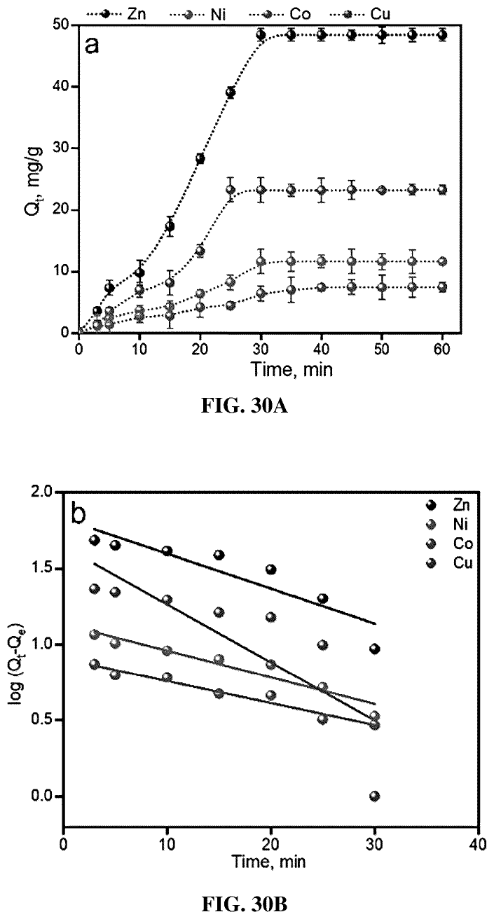

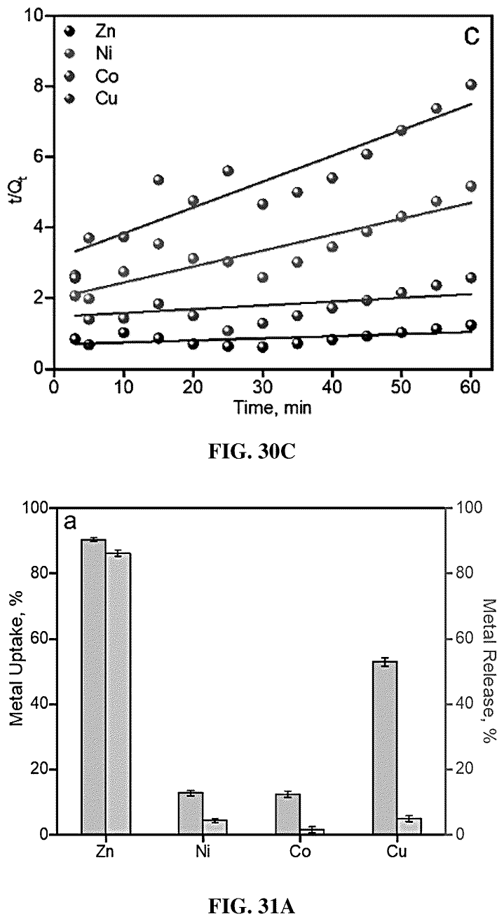

The kinetics of metal adsorption on the Si-A₂-NB adsorbent was evaluated using electrochemical capture and release. The adsorption process was studied at various contact times ranging from 0 to 60 minutes while maintaining a constant potential of −0.3V, as illustrated in FIG. 30A. The findings demonstrated that the electrochemical adsorption occurred spontaneously, with the amount of Zn adsorbed by Si-A₂-NB increasing rapidly within the initial 20 minutes. Subsequently, the adsorption rate gradually slowed down, eventually reaching equilibrium at 30 min.

The adsorption process of Zn was evaluated using pseudo-first-order (PFO) and pseudo-second-order (PSO) kinetic models. The experimental kinetic data was fitted to these models using equations described in the experimental section, and the fitted plots are presented in FIGS. 30B and 30C. The parameters and correlation coefficients (R²) obtained from the PFO and PSO models are given in Table 6. The good fit of the PFO adsorption model suggests that the adsorption process is strongly influenced by the concentration of metal ions in the solution and involves significant chemical interactions within the adsorption mechanism. The PFO fitted model (K1 value from Table 6) shows a low Zn adsorption time, and the R² value is close to 0.8305. This indicates a very fast initial rate of adsorption compared to the PSO model. Moreover, Zn exhibits an increased adsorption capacity (Qₑ) of approximately 48.9 mg/g compared to other metals due to its potential to undergo chemical interactions during the adsorption process. Based on these findings, it can be concluded that the adsorption rate of Zn is higher than that of other metals and is better described by Lagergren's pseudo-first-order adsorption kinetics rather than pseudo-second-order adsorption kinetics, as indicated by the higher determination coefficient (R²) of the PFO data simulation.

### Si-A₂-NB (Mode 2); Metal Uptake, Release and Regeneration Cycles

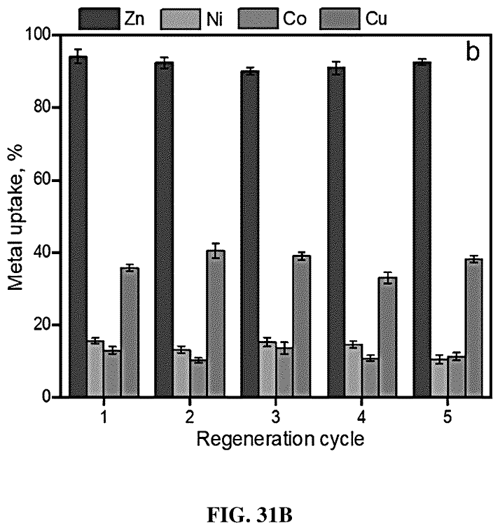

The electrochemical regeneration of the redox-active working electrode systems to recover the desired metals was assessed. Typically, the adsorbed ions must be stripped in order to reuse the adsorbent in subsequent adsorption processes. Traditional ion exchange methods generally involve stripping with strong acids or bases, leading to the generation of hazardous and corrosive waste streams. However, the combination of redox-active moieties with silica-60 allows for a purely electrochemically controlled regeneration of the adsorbent. Unlike conventional adsorbents, this approach only requires electricity for desorption, eliminating the need for highly acidic or alkaline stripping reagents. The release of bound metals into the solution was achieved through electrostatic repulsion of the positively charged N and O atoms in the redox-active moieties, facilitated by electrochemically driven oxidation. To investigate the electrosorption of metals loaded on the Si-A₂-NB electrode, various positive potentials (+0.2V) were applied (FIG. 31A) for 1 hour to release the adsorbed metals into a 0.5 M NaCl electrolyte. As depicted in FIG. 31A, Si-A₂-NB demonstrated nearly complete regeneration when applying +0.2 V during the first cycle of desorption, without using any acidic or other chemical additives for stripping. The increase in Zn content after adsorption and its close-to-complete removal after electrochemical regeneration further validate the efficiency of the process.

The regeneration of Si-_{A2}-NB was tested over five cycles (FIG. 31B). The oxidation states of NB on the surface of pristine Silica-60 and after Zn adsorption were found to be similar, indicating that most of the N and O sites were in a reduced state in both cases. However, after regeneration (desorption) of the Si-A₂-NB electrode via chronoamperometry at +0.2 V (vs. Ag/AgCl) in 0.5 M NaCl for 1 hour, the N and O sites were oxidized, suggesting that the desorption mechanism could be attributed to the oxidation of NB. To ensure the reusability of the Si-A₂-NB electrode, the oxidized O⁺ and N⁺ must be reduced back to O and N, respectively, to initiate a new cycle of adsorption. Complete reduction of the Si-A₂-NB can help avoid excessive positive charges that could repel metal cations and limit metal uptake. The desorption capabilities remained relatively constant over the recycling runs, with an average recovery of around 90% of Zn achieved through electrochemical regeneration.

### Characterization of Si-AEPTS-ARS

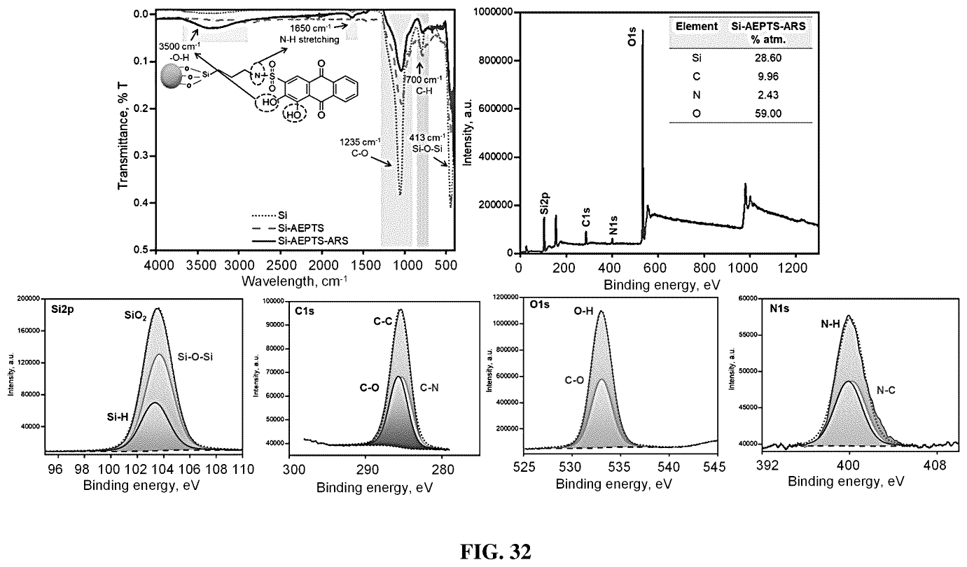

To determine the functional groups of mesoporous silica and modified silica (Si-AEPTS-ARS), FT-IR characterization was carried out. The FT-IR spectra of the pristine mesoporous silica-60 and the modified Si-AEPTS and Si-AEPTS-ARS are shown in FIG. 32. There were several forms of silanol groups on the silica surface, including isolated, hydrogen-bonded, and germinal varieties. The asymmetrical stretching vibration of Si—O from the siloxane (Si—O—Si) group was responsible for the absorption peak at 1041 cm⁻¹. The absorption peak at wave number 800 cm⁻¹ indicates that the Si—O symmetry of Si—O—Si was present. The weak vibration bands bending vibrations of Si—O—Si groups at 413 cm⁻¹. The results of AEPTS modified silica showed an absorption peak at 1650 cm⁻¹ indicating the presence of stretching vibration in primary amine from AEPTS. Tethering of ARS onto Si-AEPTS was achieved and the identification peak was noted as 3500 cm⁻¹ as —O—H formation. Appearance of primary amine group and hydroxyl group in Si-AEPTS-ARS shows that ARS was successfully tethered on Si-AEPTS and chemical bond formation between ARS and AEPTS.

FIG. 32 provides evidence that the chemical state of silicon was SiO₂. Tethering of ARS on Si-AEPTS was confirmed based on the binding energy changes and atomic percentage for Si, C, N and O i.e., 28.60%, 9.96%, 2.43%, 59.00%, respectively. The binding energy of about 285 eV was associated with C1s where the C—C bond showed a binding energy peak at 284.3 eV, C—N bond showed at 286.1 eV and C—O bond showed at 283.5 eV. For Ols, the binding energy was associated at 532.9 eV which was associated to O—H and C—O peak. The binding energy at 103.50 eV corelated to Si—O peak position where it can be distributed into two peaks, one with SiO₂ and another with Si—O—Si. A peak change was observed in the case of N is associated with another element, where the binding energy peak position at 398 eV indicate N was connected with other atoms like O and C. These changes in XPS peak position and distribution along with its associated binding energy indicated that ARS and AEPTS had been grafted on the surface of silica.

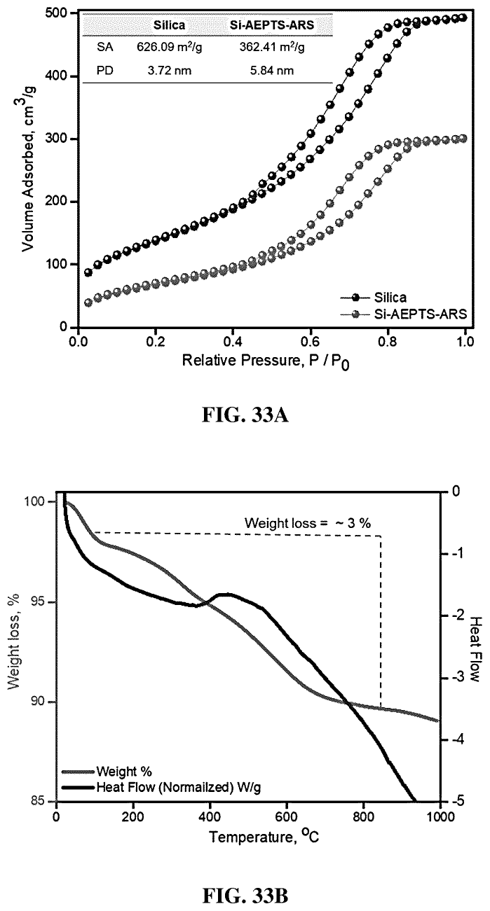

Consequently, the surface parameters, such as the specific surface area, pore volume and pore radius of the functionalized silica also changed significantly (FIG. 33A). The BET surface area of the modified silica had relatively decreased pore size value as pristine and after ligand tethering i.e., about 3.72 nm which shows that there was not significant pore size modification by ligand. Si-AEPTS-ARS had a lower exterior surface area, about 362.41 m²/g, than pure silica (about 626.09 m²/g), which may lead to more surface contacts and tethering of redox active ligand, meaning that there is potential for a much higher ligand loading.

Thermogravimetric analyses of the functionalized silica were performed from 0° C. to 1000° C. to test the thermal stability of the functional material (FIG. 33B). A small weight loss (about 3 wt. %) occurred below 150° C. which was associated with the water physically adsorbed on surface. A continuous and small weight loss was observed above 600° C., which could be attributed to the combustion of residual organic material or desorption of water resulting from silanol condensation. In this example, the total weight loss observed was about 3%.

### Si-AEPTS-ARS; Mode 1: Proton-Exchange Method/Adsorption-Desorption (pH Swing)

### Si-AEPTS-ARS (Mode 1); Effect of Solution pH on Metal Adsorption

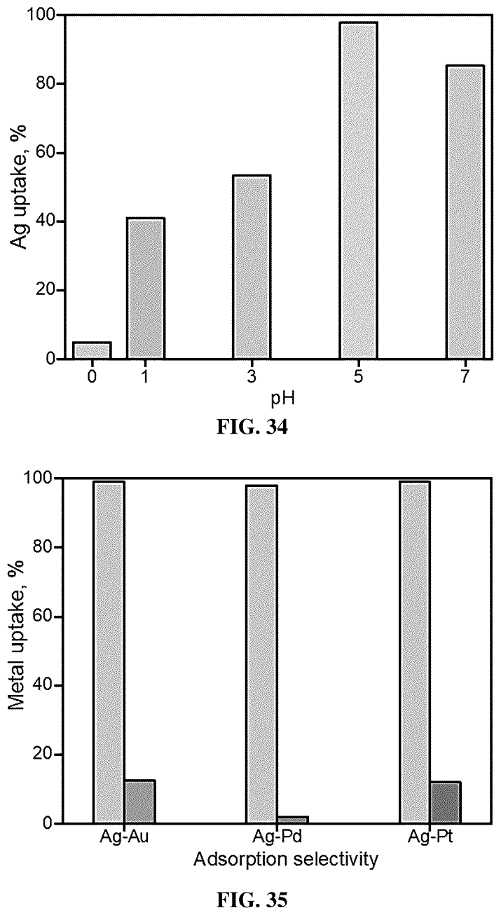

A solution pH influences the behavior in controlling the adsorption process by the ligand based conjugate nanomaterials during metals sorption. Activity of adsorbent surface charge and functional group may vary when the pH of the solution changes. Silver, however, did not easily hydrolyze or form complexes; as a result, it existed in the solution as Ag throughout a wide pH range (from 0 to 7). The Ag uptake efficiency as a function of pH is shown in FIG. 34. An increase in solution pH resulted in a considerable increase in Ag sorption. According to FIG. 34, the Si-AEPTS-ARS achieved its highest Ag sorption efficiency at pH 5. However, most of the surface sorption sites were deprotonated at high pH regions, which greatly increased the possibility of electrostatic interactions and allowed for extremely high efficiency silver uptake. In many cases, it is plausible that the metals form coordinate covalent bonds with ligands where the metal donates a pair of electrons to the ligand, forming a shared pair of electrons between the metal and the ligand. Accordingly, pH 5 was used to examine other experimental parameters.

Generally, the effect of pH on adsorption capacity was investigated by adjusting a solution of metals at desired pH values using either dilute HNO₃ or NaOH solution. The initial and final concentrations of metals were determined in the same manner as mentioned earlier, where the corresponding stock with the specifically tested pH was compared to the solution in the experiment with the same initial pH level.

### Si-AEPTS-ARS (Mode 1); Selectivity of Metal Uptake

Adsorption selectivity of metal uptake on Si-AEPTS-ARS was examined by measuring the mixture of the target elements i.e., 100 ppm Ag—Au, Ag—Pd, and Ag—Pt mixture, as shown in FIG. 35; Ag (about 99%) uptake is very selective in respect to Au (about 18%), Pd (about 3%) and Pt (about 14%) metals.

### Si-AEPTS-ARS (Mode 1); Regeneration

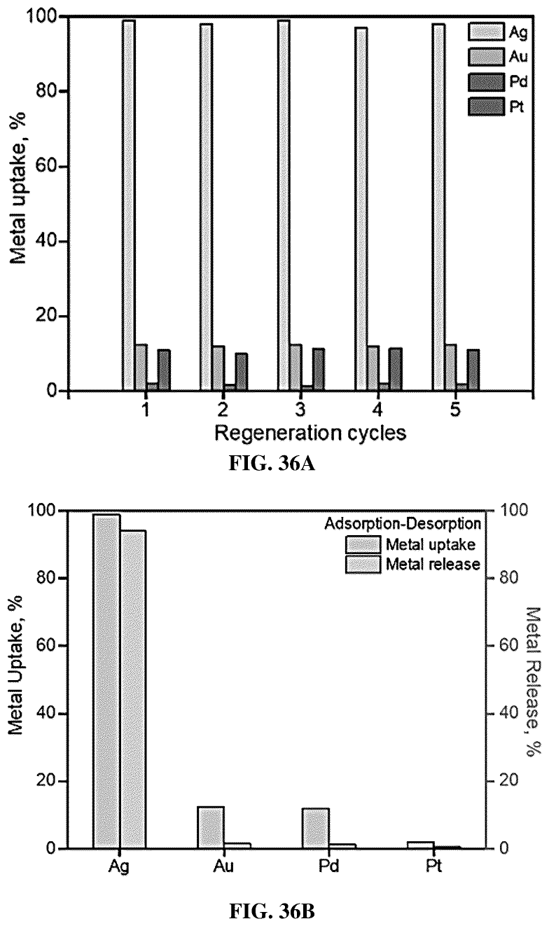

Sorption-elution-regeneration processes were conducted to investigate the possibility of chemically eluting and regenerating the sorbent material, Si-AEPTS-ARS, for five cycles. The sorption efficiency of each cycle was compared with the initial sorption efficiency of Si-AEPTS-ARS. The experimental results, shown in FIGS. 36A and 36B, demonstrated that using a low concentration of HCl acid (0.05 M) effectively eluted the adsorbed Ag, allowing the adsorbent to retain its functionality. Approximately 99% of the Ag was successfully eluted from the adsorbent using an optimal concentration of 0.05 M HCl. This indicates that an acidic condition facilitates the desorption of Ag from the exhausted adsorbents. Consequently, Si-AEPTS-ARS is an adsorbent that may be used for efficient Ag recovery from the mixture of Ag, Au, Pd, and Pt, and other mixtures.

During the regeneration process, Si-AEPTS-ARS was simultaneously restored to its initial form after being washed with water for Ag capture. The adsorbent did not experience a significant loss in its adsorption capacities. Thus, Si-AEPTS-ARS can be effectively reused for subsequent sorption operations, maintaining its performance.

### Characterization of Si-M-VF

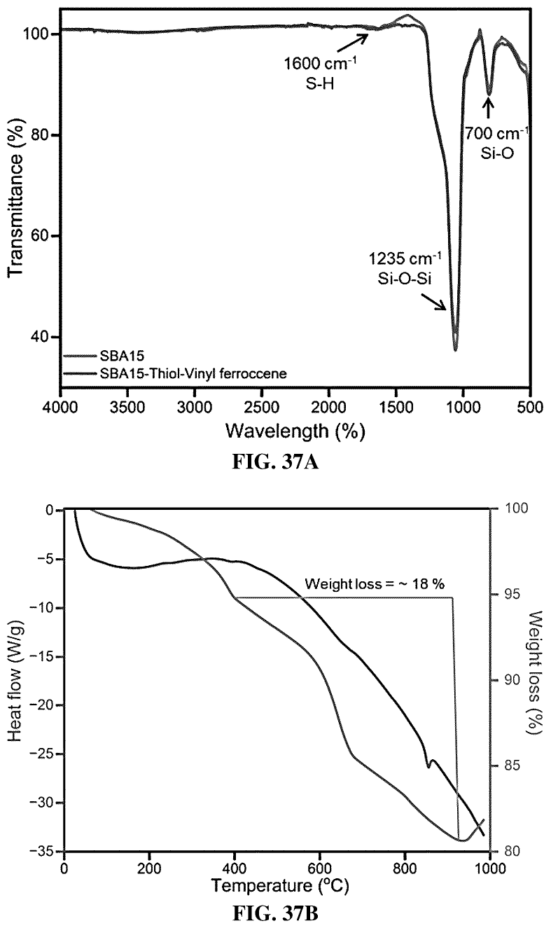

To determine the functional groups of mesoporous silica and modified silica (Si-M-VF), FT-IR characterization was carried out. The FT-IR spectra of the pristine mesoporous silica SBA15 and the modified Si-M-VF are shown in FIG. 37A. There are several forms of silanol groups on the silica surface, including isolated, hydrogen-bonded, and germinal varieties. The asymmetrical stretching vibration of Si—O from the siloxane (Si—O—Si) group is responsible for the absorption peak at 1041 cm⁻¹. The absorption peak at wave number 800 cm⁻¹ indicates that the Si—O symmetry of Si—O—Si was present. The weak vibration bands bending vibrations of Si—O—Si groups at 413 cm⁻¹. The results of M modified silica showed an absorption peak at 1600 cm⁻¹ indicating the presence of stretching vibration in thiol group presented in linker. Tethering of VF onto Si-M was achieved and the identification peak was noted as 1600 cm⁻¹ as —S—CH formation, indicating that VF was successfully tethered on Si-M and chemical bond formation between VF and M.

Thermogravimetric analyses of the functionalized silica were performed from 0° C. to 1000° C. to test the thermal stability of the functional material (FIG. 37B). A small weight loss (about 3 wt. %) occurred below 150° C. which was associated with the water physically adsorbed on surface. A continuous and small weight loss was observed above 600° C., which could be attributed to the combustion of residual organic material or desorption of water resulting from silanol condensation. In this example, the total weight loss observed was about 18%.

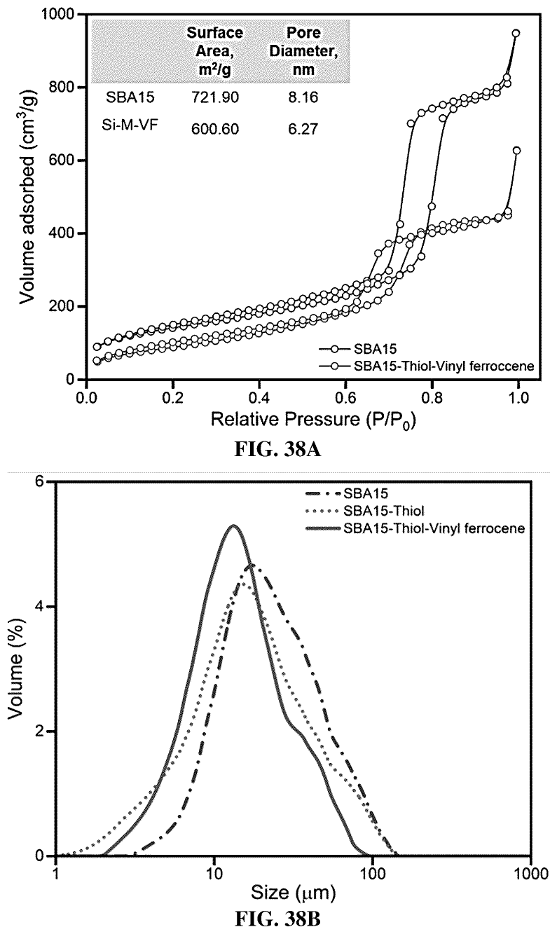

Consequently, the surface parameters, such as the specific surface area, pore volume and pore radius of the functionalized silica also changed significantly (FIG. 38A). The BET surface area of the modified SBA15 had decreased pore size value as pristine and after ligand tethering i.e., about 6.27 nm which shows that there was significant pore size modification by ligand. Si-M-VF had a lower the exterior surface area, about 600.60 m²/g, than pure silica (about 721.90 m²/g), which may result in more surface contacts and tethering of redox active ligand, meaning that there potential for a much higher ligand loading.

As shown in FIG. 38B, it was observed that the particle size of pristine silica is about 10 μm whereas the size of Si-M-VF is about 10 μm and with fine distribution peak, which shows that the ligand was tethered onto the silica (e.g., SBA15) without interfering in its particle size.

In some embodiments, Si-M-VF can be used in the separation of nickel from the mixture of iron and nickel.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a composition or article that “comprises,” “has,” “includes,” or “contains” one or more features possesses those one or more features, but is not limited to possessing only those one or more features.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In some instances, the approximating language may correspond to the precision of an instrument for measuring the value.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Embodiments of the inventive method are distinguished from the disclosures within the references discussed herein.

Where one or more ranges are referred to throughout this specification, each range is intended to be a shorthand format for presenting information, where the range is understood to encompass each discrete point within the range, and further to encompass any subrange within the range between any discrete point within the range and any other discrete point within the range, as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

1-47. (canceled)

48. A method of producing one or more metal hydroxide, oxide, and/or carbonate compounds and/or recovering one or more metals comprising:
providing an apparatus comprising an anode, a cathode, a liquid electrolyte, and optionally a separator membrane between the anode and the cathode:
providing one or more precursor compounds comprising one or more metal-bearing materials wherein the one or more precursor compounds are substantially insoluble in the liquid electrolyte and located in a first location;
applying a voltage between the anode and the cathode;
dissolving at least part of the one or more precursor compounds to form one or more soluble metal ions diffused in at least part of the liquid electrolyte as a metal-containing solution; and
accumulating one or more metal hydroxide, oxide, and/or carbonate compounds substantially in a second location different from the first location, wherein the one or more metal hydroxide, oxide, and/or carbonate compounds are substantially insoluble in water or in the liquid electrolyte.

49. The method of claim 48, wherein the apparatus comprises:
a first chamber comprising the anode;
a second chamber comprising the cathode;
a conduit connecting the first chamber and the second chamber; and
optionally a separator placed in the conduit;
wherein the liquid electrolyte comprising a solvent and optionally one or more additives;
wherein the one or more metal-bearing siliceous materials are positioned inside the first chamber and optionally close to the anode, wherein at least part of the one or more metal-bearing siliceous materials are dissolved in the solvent under the applied voltage for a time period by reacting with the H⁺ in the first chamber generated at or close to the anode; and
wherein the one or more metal hydroxides, oxides, or carbonates, are accumulated substantially in the lower half of the conduit and/or in the lower half of the second chamber by reacting the soluble metal ion(s) with the OH⁻ diffused to the conduit from the second chamber wherein the OH⁻ is generated at or close to the cathode under the applied voltage by electrochemical reaction(s).

50. The method of claim 48, wherein dissolving at least part of the one or more precursor compounds comprise one or more reactions of:
i. M1ₓ₁M2ₓ₂M3ₓ₃SiO_{y}+n1 H+→a1 M1^{b1+}+a2 M2^{b2+}+a3 M3^{b3+}+n2 SiO₂+n3 H₂O, wherein 0≤x1≤4, 0≤x2≤4, 0≤x3≤4, 1≤y≤8, x1+x2+x3>0, a1+a2+a3>0, b1≥1, b2≥1, b3≥1, n1>0, n2>0, and n3>0;
ii. M1ₓ₁M2ₓ₂M3ₓ₃O_{y}+n1 H+→a1 M1^{b1+}+a2 M2^{b2+}+a3 M3^{b3+}+n2 O₂+n3 H₂O, wherein 0≤x1≤4, 0≤x2≤4, 0≤x3≤4, 1≤y≤8, x1+x2+x3>0, a1+a2+a3>0, b1≥1, b2≥1, b3≥1, n1>0, n2>0, and n3>0;
iii. M1ₓ₁M2ₓ₂M3ₓ₃Alₓ₄Siₓ₅Oy+n1 H+→a1 M1^{b1+}+a2 M2^{b2+}+a3 M3^{b3+}+n2 SiO₂+n4 Al₂O₃+n3 H₂O, wherein 0≤x1≤4, 0≤x2≤4, 0≤x3≤4, 0≤x4≤4, 0≤x5≤4, 1≤y≤8, x1+x2+x3>0, a1+a2+a3>0, b1≥1, b2≥1, b3≥1, n1>0, n2>0, n3>0, and n4>0; and/or
iv. M1ₓ₁M2ₓ₂M3ₓ₃(OH)_{y}+n1 H+→a1 M1^{b1+}+a2 M2^{b2+}+a3 M3^{b3+}+n2 (OH)_{y}+n3 H₂O, wherein 0≤x1≤4, 0≤x2≤4, 0≤x3≤4, 1≤y≤8, x1+x2+x3>0, a1+a2+a3>0, b1≥1, b2≥1, b3≥1, n1>0, n2>0, and n3>0.

51. (canceled)

52. The method of claim 50, wherein each of M1, M2, and M3 are independently selected from Ca, Mg, Al, Fe, Mn, Pb, Ni, Co, Zn, Cu, Mo, Pt, Pd, Rh, Ru, Ir, Os, La, Ce, Pr, Nd, Pm, Sm, Eu, Gd, Tb, Dy, Ho, Er, Tm, Yb, Lu, Sc, and Y.

53-55. (canceled)

56. The method of claim 48, wherein the one or more precursor compounds comprise steel slag, minerals, mine-tailings, industrial residues, rocks, fly ash, ores, or brine with dissolved solids, and/or wherein the one or more precursor compounds comprise one or more metal-bearing siliceous materials selected from wollastonite, enstatite, olivine, basalt, serpentine, pyroxene, diopside, feldspar, mica, talc, sulfide ores, or gypsum, or is composed of or derived from rocks or ores containing one or more of metal silicates.

57-58. (canceled)

59. The method of claim 48, wherein the anode is at least partially submerged in the electrolyte and configured to generate acid; and wherein the cathode is at least partially submerged in the electrolyte and configured to generate hydroxyl ions.

60. (canceled)

61. The method of claim 49, wherein the conduit has a pH gradience from a first pH value that is acidic to a second pH value that is basic.

62-63. (canceled)

64. The method of claim 48, further comprising:
introducing a gas stream comprising carbon dioxide;
absorbing at least part of the carbon dioxide by reacting the carbon dioxide with the one or more metal hydroxides or oxides to form one or more metal carbonates.

65. The method of claim 48, wherein the first location and the second location are separated by at least one filter or membrane or at least one porous material.

66. (canceled)

67. The method of claim 48, further comprising:
providing a functionalized sorbent for metal capture;
capturing the metal from the metal-containing solution onto the functionalized sorbent at a negative potential; and
releasing the metal from the functionalized sorbent at a positive potential, thereby regenerating the working electrode.

68. The method of claim 67, wherein the functionalized sorbent comprises:
a substrate;
a redox active ligand; and
optionally a linker;
wherein the ligand is directly attached to the substrate or tethered to the substrate via the linker.

69-70. (canceled)

71. The method of claim 68, wherein the ligand is selected from Nile Blue (NB), 3,4-Dihydroxy-9,10-dioxo-9,10-dihydroanthracene-2-sulfonic acid (Alizarin Red S; ARS), and vinyl-ferrocene (VF).

72. The method of claim 68, wherein the linker is selected from 3-(2-aminoethylamino) propyltrimethoxysilane (A₂), 3-(aminopropyl)triethoxy silane (AEPTS), and 3-mercaptopropyl trimethoxysilane (M).

73-77. (canceled)

78. The method of claim 48, further comprising:
providing a functionalized sorbent for metal capture;
recovering the metal from the metal-containing solution by contacting the functionalized sorbent with the metal-containing solution, thereby adsorbing metal ions from the metal-containing solution onto the functionalized sorbent, wherein the functionalized sorbent comprising an electroactive surface having one or more ligands tethered thereon, said surface being, due to the one or more ligands, highly selective for electrochemical adsorption and/or desorption from metal bearing solutions; and
desorbing the metal ions from the functionalized sorbent by contacting the functionalized sorbent with a stripping agent, thereby forming a stripped solution containing the metal ions.

79. The method of claim 78, wherein the one or more ligands are highly selective for electrochemical adsorption and/or desorption of one or more metals selected from Pt, Pd, Ni, Mn, Co, Cu, Ag, Fe, La, Ce, or any combinations thereof.

80. The method of claim 78, wherein the functionalized sorbent comprises Si-M-VIL of formula:

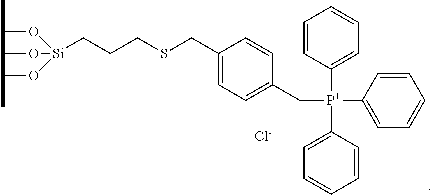 [SMILES: C[C@@H]1O[Si]2(CCCSCc3ccc(C[P+](c4ccccc4)(c4ccccc4)c4ccccc4)cc3)O[C@@H]1[C@@H](C)O2 ; [Cl-]]

81. The method of claim 80, wherein the ligand of the functionalized sorbent is highly selective for electrochemical adsorption and/or desorption of platinum for recovering platinum from the metal-containing solution.

82. The method of claim 48, wherein the apparatus comprises:
a first chamber comprising an anode;
a second chamber comprising a cathode;
a conduit connecting the first chamber and the second chamber;
optionally a separator configured to separate the anode and cathode;
an electrolyte comprising a solvent and optionally one or more additives; and
one or more metal-bearing siliceous materials positioned inside the first chamber and optionally close to the anode, wherein at least part of the one or more metal-bearing siliceous materials are dissolved in the solvent/electrolyte, and one or more products are produced under an applied voltage for a time period, wherein the one or more products are selected from one or more metal hydroxides, silica, one or more metal ion dissolved in the solvent/electrolyte, hydrogen, oxygen, optionally one or more metal carbonates, optionally one or more metal oxides, or any combination thereof.

83. The method of claim 82, further comprising:
a first filter or membrane positioned between the first chamber and a first end of the conduit; and
optionally a second filter or membrane positioned between the second chamber and a second end of the conduit,
wherein the first filter or membrane is configured to prevent the one or more metal-bearing siliceous materials from diffusing to the conduit from the first chamber and wherein the second filter or membrane is configured to prevent the one or more products from diffusing to the second chamber from the conduit.

84. The method of claim 82, wherein four or more products are produced comprising:
one or more metal hydroxides accumulated substantially on the lower half of the conduit;
a silica material accumulated substantially on the lower half of the first chamber;
oxygen accumulated substantially at the upper half of the first chamber;
hydrogen accumulated substantially at the upper half of the second chamber;
optionally one or more dissolved metal ions primarily concentrated in the first chamber converted from the one or more metal-bearing siliceous materials wherein the concentrated metal is selected from Ca, Mg, Al, and Fe; and
optionally one or more metal carbonates, hydroxides, and/or oxides accumulated substantially on the lower half of the conduit or on the lower half of the second chamber, wherein the metal of the metal carbonates, hydroxides, and/or oxides, is selected from Mn, Pb, Ni, Co, Zn, Cu, Mo, Pt, Pd, Rh, Ru, Ir, Os, La, Ce, Pr, Nd, Pm, Sm, Eu, Gd, Tb, Dy, Ho, Er, Tm, Yb, Lu, Sc, and Y.
